(19) United States
(12) Patent Application Publication
(10) Pub. No.: US 2023/0334957 A1
(43) Pub. Date: Oct. 19, 2023

(54) SYSTEM AND METHOD FOR A SPORTS GAMBLING PLATFORM

(71) Applicant: PEERGAMING LLC, Randallstown, MD (US)

(72) Inventor: Richard Olaniyi Owoyemi, Towson, MD (US)

(21) Appl. No.: 18/104,374

(22) Filed: Feb. 1, 2023

Related U.S. Application Data
(63) Continuation of application No. PCT/US2022/050511, filed on Nov. 19, 2022.
(60) Provisional application No. 63/343,867, filed on May 19, 2022.
(60) Provisional application No. 63/331,856, filed on Apr. 17, 2022.

(51) Int. Cl. G07F 17/32

(52) U.S. Cl. CPC G07F 17/3288; G07F 17/323; G07F 17/3258; G07F 17/3274

(57) ABSTRACT

A system and method for an online sports betting system, including individual users, multiple users or syndicates, a bracket-style tournament model wherein each individual user or syndicate competes in a peer-to-peer contest or tournament which includes odds selections for a short-term period, such as a week or single day of competition but not limited to a long-term period whereby each competition betting slip may comprise of one or more odds selections. Each betting slip has a constraint of maximum odds and selections caps, whereby the system revolves around accumulating higher correct odds points predictions compared to multiple other players under the specified constraints.

### CROSS-REFERENCE TO RELATED APPLICATIONS

This application is a Continuation of PCT Application No. PCT/US22/50511 filed on Nov. 19, 2022, which claims priority to U.S. Provisional Application 63/331,856 filed on Apr. 17, 2022, and U.S. Provisional Application 63/343,867 filed on May 19, 2022. The content of each of the above applications is hereby expressly incorporated by reference herein in its entirety.

### FIELD OF DISCLOSURE

The broad field of this invention generally relates to systems and methods for operating X-League sports betting competitions.

### BACKGROUND

Sports betting has become a trendy way of earning money in the fast-paced gambling industry, providing entertainment and increasing viewership to sports fans and spectators. Sports betting uses sports like football, soccer, horse or dog racing, basketball, and the like for contests against the house or amongst multiple sports bettors while utilizing online or offline distribution channels. In Sports betting, the bettors predict game winners and place a wager on the game’s outcome. One type of sports betting that involves multiple sports bettors is Daily Fantasy Sports which mirrors season-long fantasy sports but condenses it into a shorter one whereby users draft a player roster. Those athletes earn points based on their in-game performance. Winners are then decided based on the ranking of the cumulative point scored among the users. This approach involves player selections instead of odds selections, making a cross-play to widespread sports betting formats involving fixed-odds betting slips unattainable. A type of wagering where bets are against the house is a parlay, where you pick several outcomes and win if you get them all correctly. However, many users become frustrated when they miss only one of the possible outcomes and lose their money. Thus, a sports betting platform that can solve these problems is needed.

### SUMMARY

It is an object of the present description to provide three systems and methods comprising Individual, Syndicate, and tournament game mechanics for operating X-League sports betting competitions. X-League was initially born out of the need to hedge parlay bets with a peer-to-peer betting contest where only the total multiplication of the winning odds in a betting slip matters to win. Like Daily Fantasy, X-League game mechanics have specified maximum caps that players in a contest cannot exceed-a maximum number of 10 selections with 50 maximum odds. Suppose an individual player enters a 10-leg selection into an X-League contest and cross-played the same selections into a Traditional Sportsbook to place a parlay bet. If the player was to lose their parlay bet because of one or more losing picks, the player might still hope to win some money at X-League. So far, the multiplication of all their winning selections ranks them into X-League prize-paying position. Syndicate betting allows an individual player to join forces with two or more players to share the risks and rewards of X-League competitions. For instance, a beginner with limited sports betting experience may join a syndicate managed by a knowledgeable sports bettor to share the payment conditions for entry fees without needing to submit a bet slip of their own. Syndicated betting helps rookie players enjoy the thrill of sports betting in the company of experienced players and is a source of unprecedented fun and bonding experience for friends and families. Lastly, the game mechanics for the disclosed bracket-style tournament allows an even contest pool of players to compete against themselves head-to-to-head for supremacy in the cumulative results of tournament rounds. The tournament’s first round starts by pairing players automatically and then pairing the winners or losers of a previous tournament round for a head-to-head contest in a current tournament round. Automatically matching-up winners or losers of a prior round in the second or more tournament rounds gives sharp players and casual players a balance of skill versus luck. Other aspects and advantages of the invention will become apparent from the following drawings, detailed descriptions, and claims, all of which illustrate the principles of the invention by way of example only.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The present invention will be described by way of exemplary embodiments, but not limitations, illustrated in the accompanying drawings in which like references denote similar elements, and in which:

FIG. 1 shows a block diagram of the various systems of the sports betting system.

FIG. 2 shows an exemplary block diagram of various components of a computing device.

FIG. 3 shows a screen of the user interface for the sports betting system.

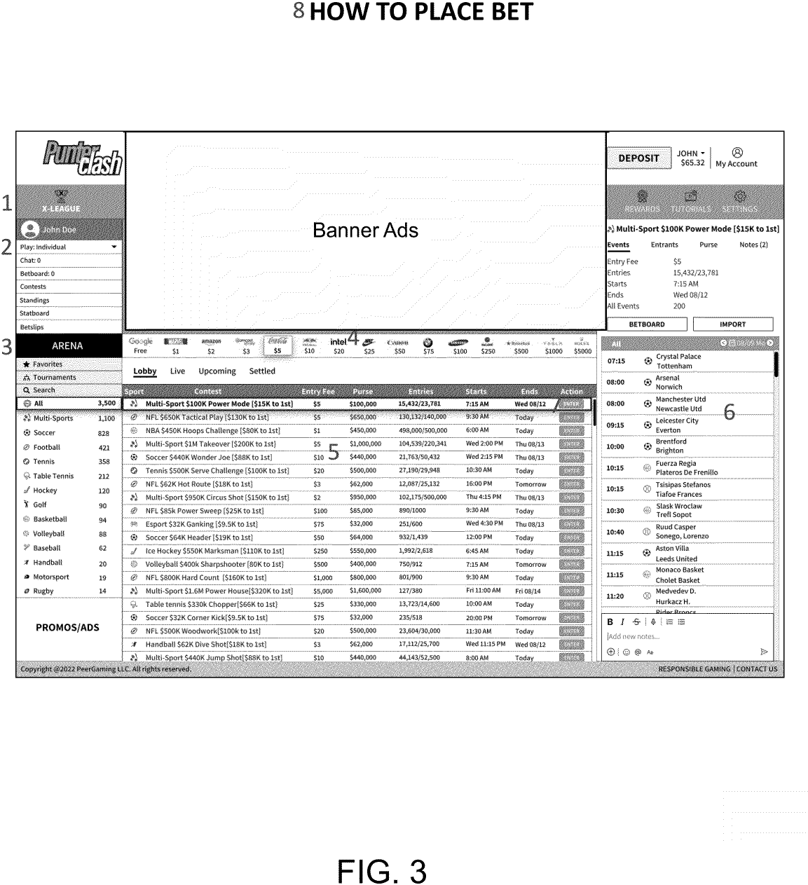

FIG. 4 shows another screen of the user interface for the sports betting system.

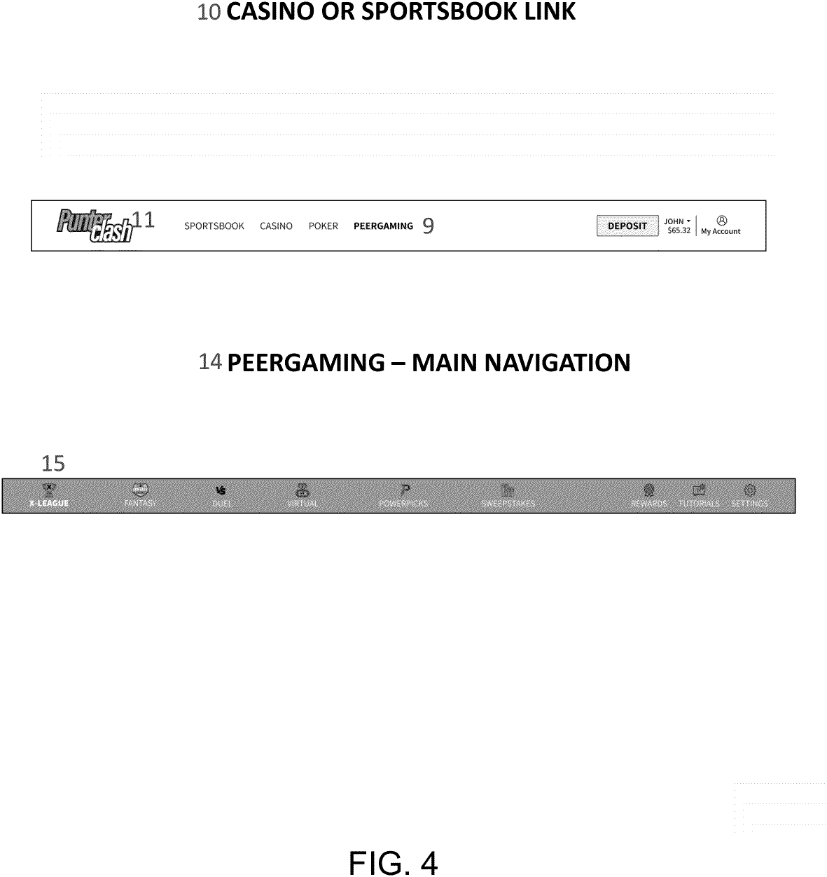

FIG. 5 shows another screen of the user interface for the sports betting system.

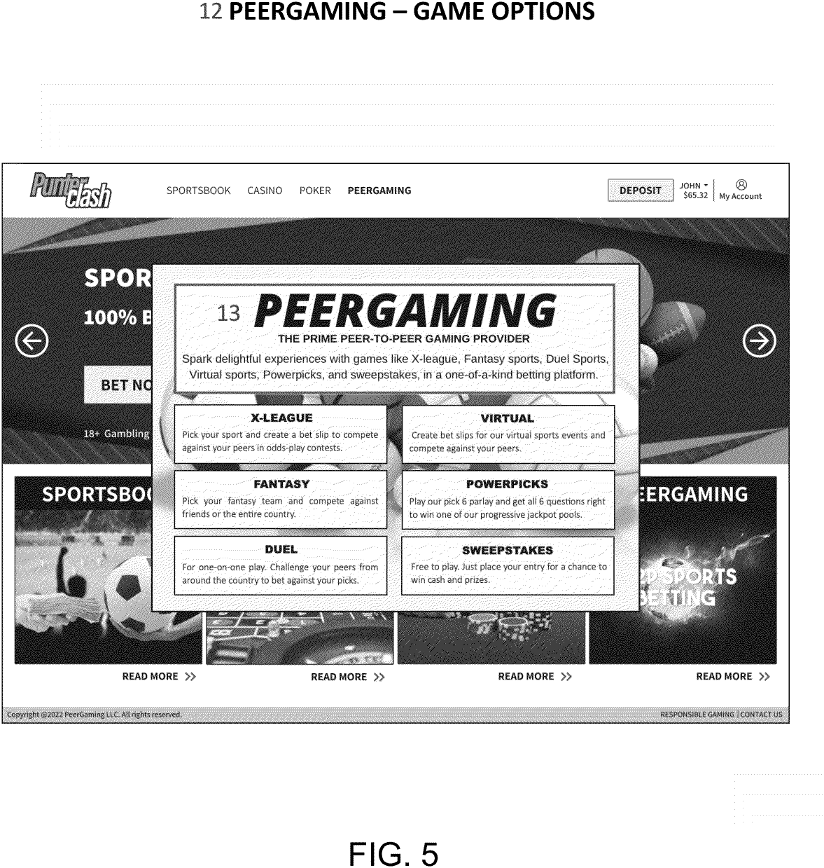

FIG. 6 shows another screen of the user interface for the sports betting system.

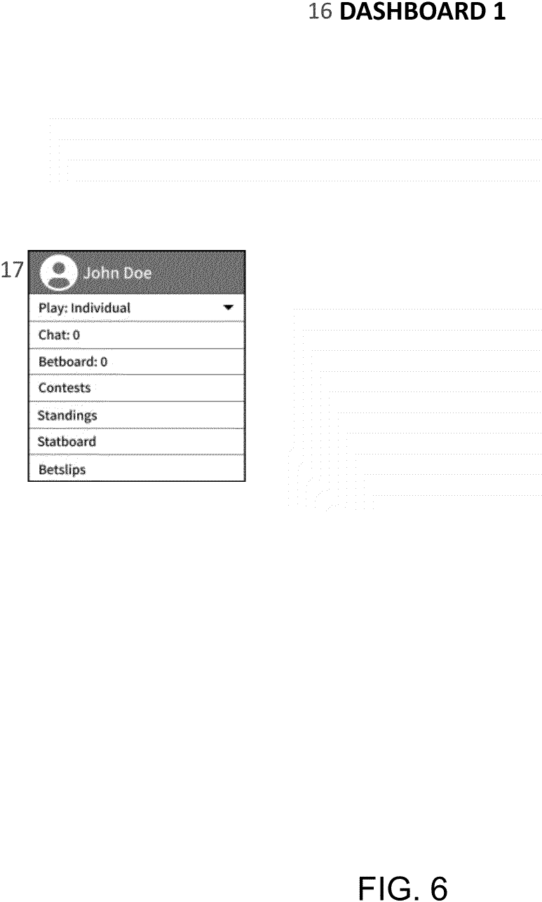

FIG. 7 shows another screen of the user interface for the sports betting system.

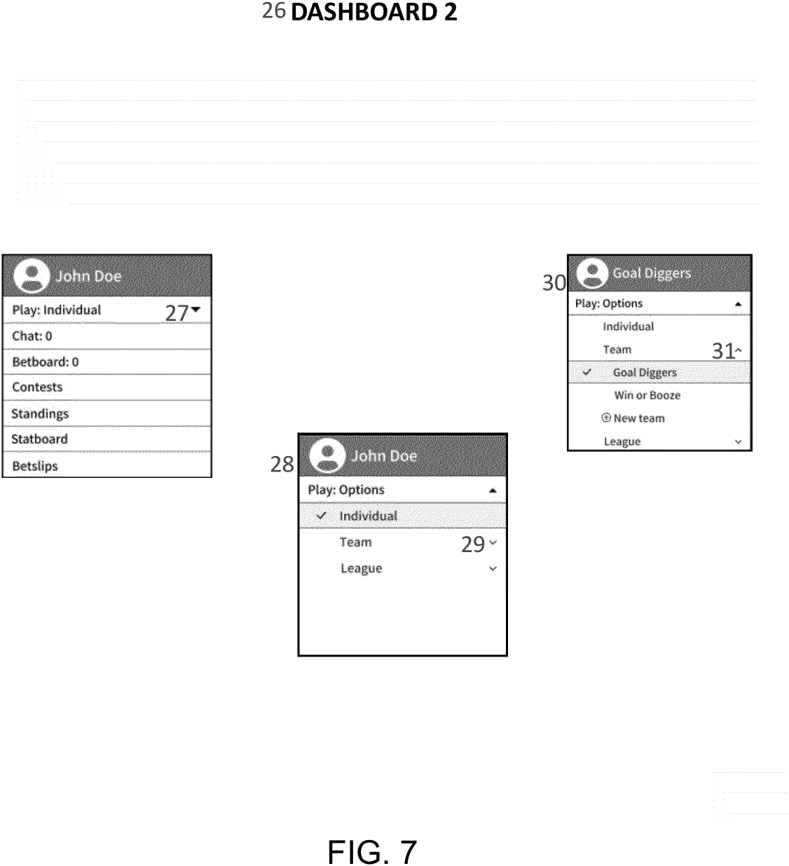

FIG. 8 shows another screen of the user interface for the sports betting system.

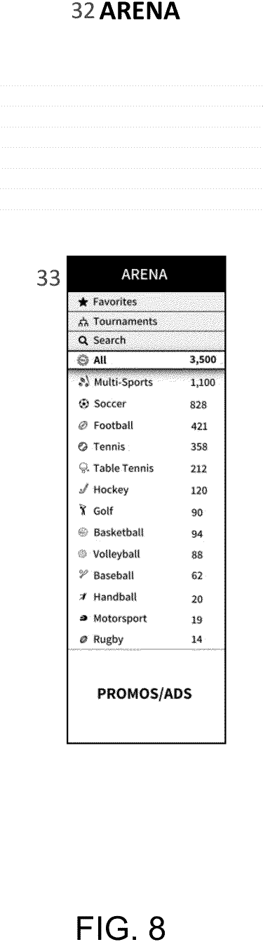

FIG. 9 shows another screen of the user interface for the sports betting system.

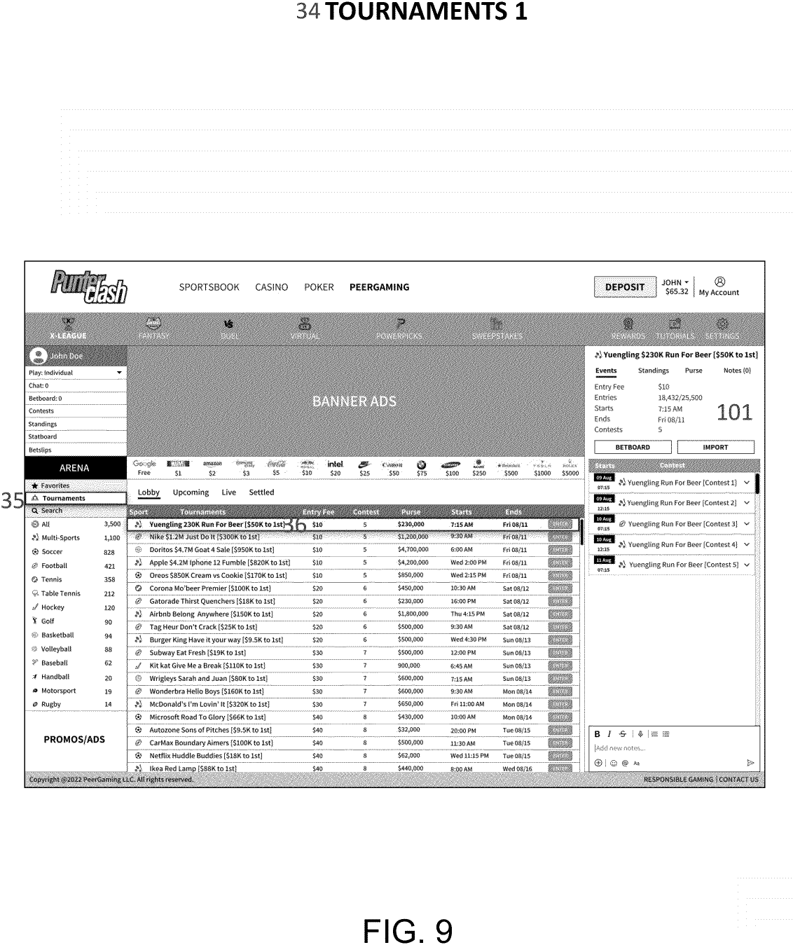

FIG. 10 shows another screen of the user interface for the sports betting system.

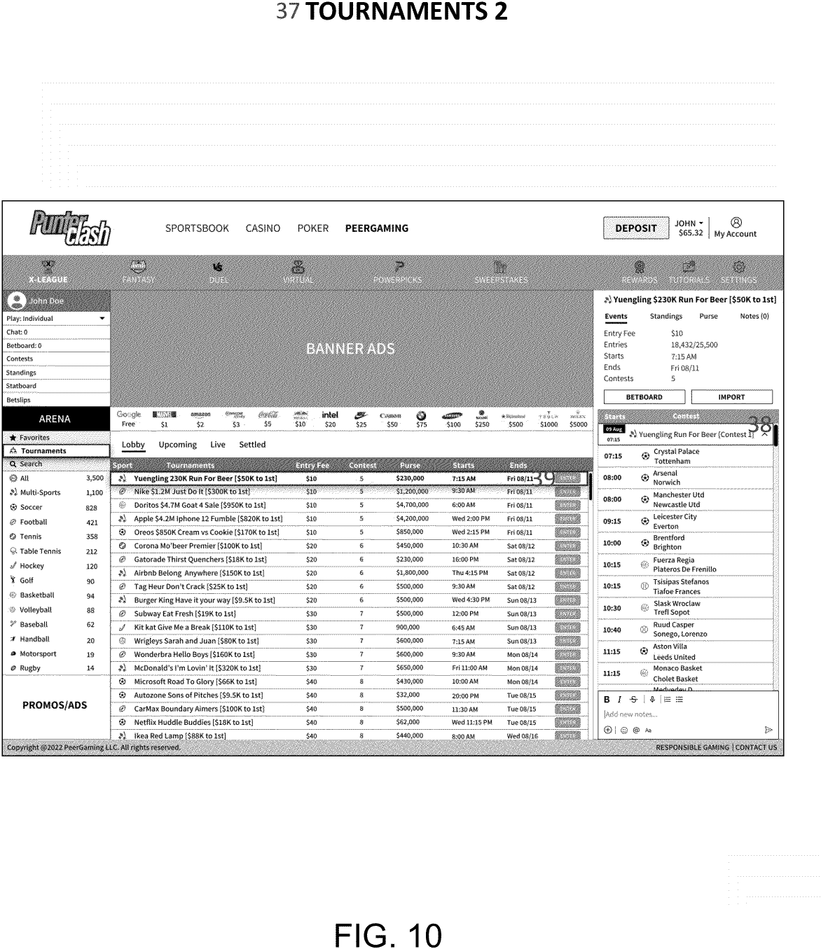

FIG. 11 shows another screen of the user interface for the sports betting system.

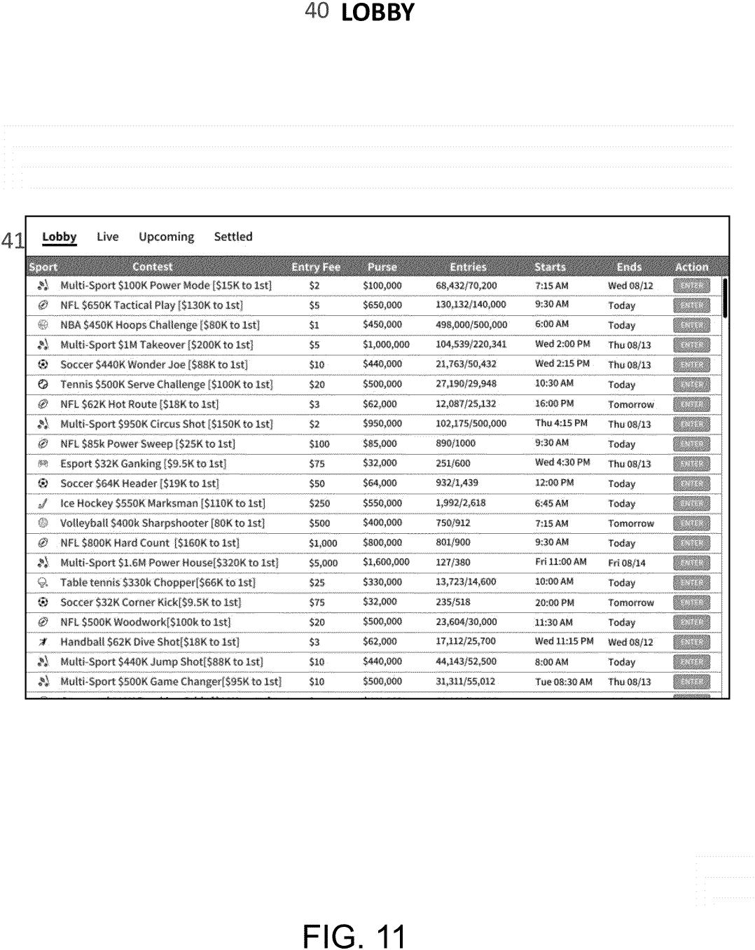

FIG. 12 shows another screen of the user interface for the sports betting system.

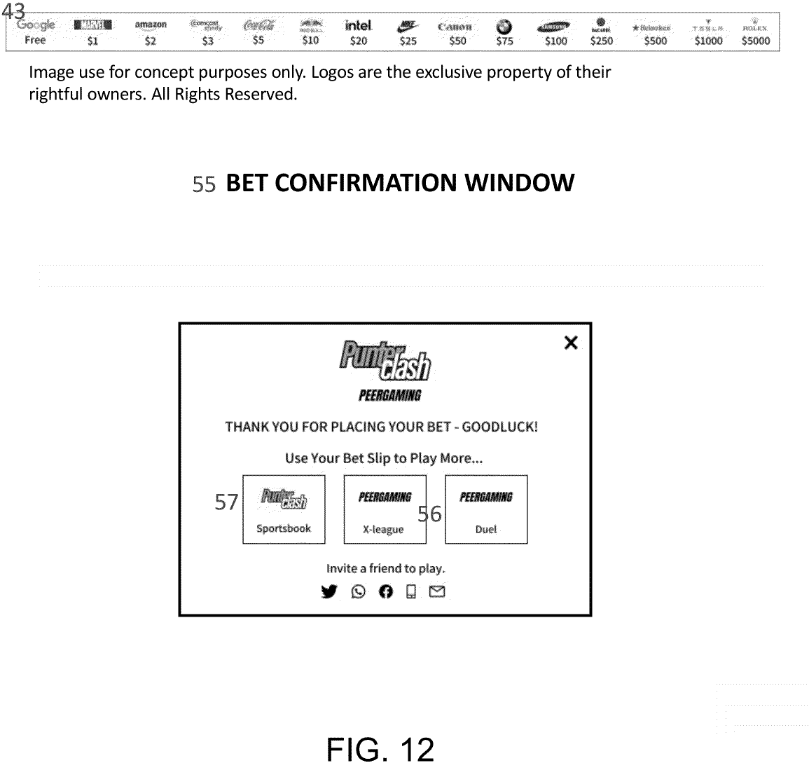

FIG. 13 shows another screen of the user interface for the sports betting system.

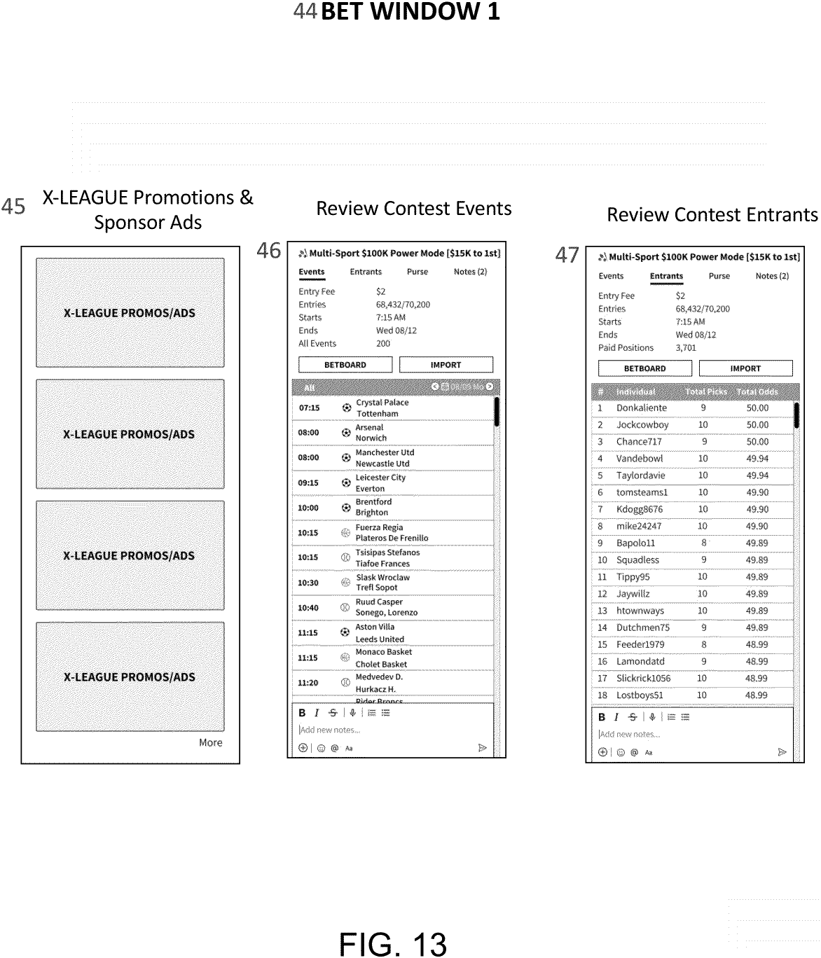

FIG. 14 shows another screen of the user interface for the sports betting system.

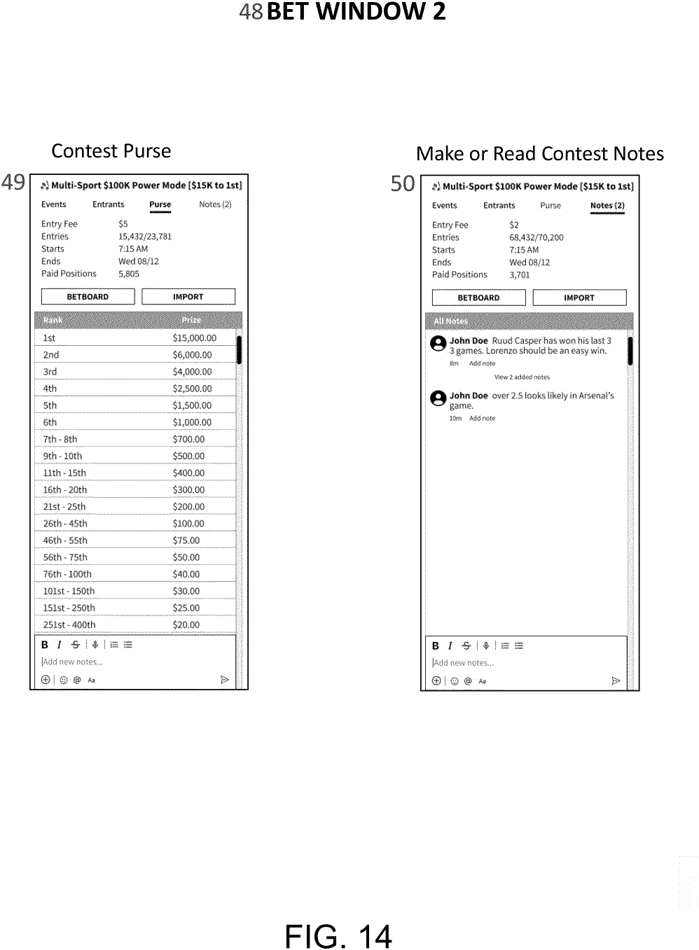

FIG. 15 shows another screen of the user interface for the sports betting system.

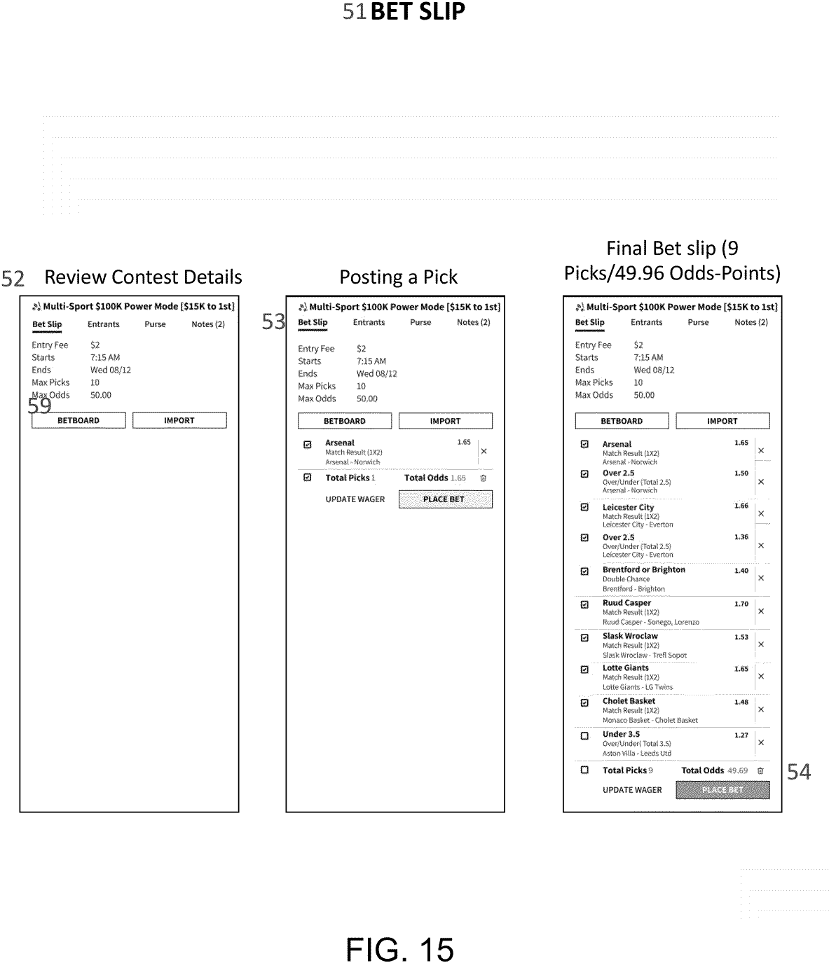

FIG. 16 shows another screen of the user interface for the sports betting system.

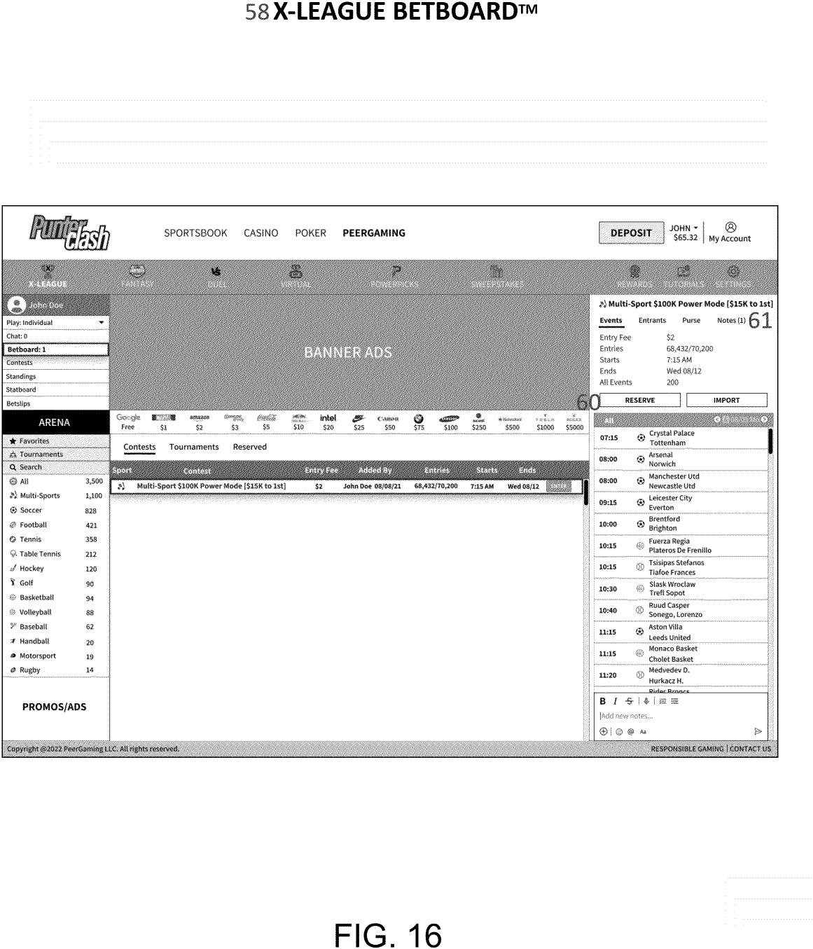

FIG. 17 shows another screen of the user interface for the sports betting system.

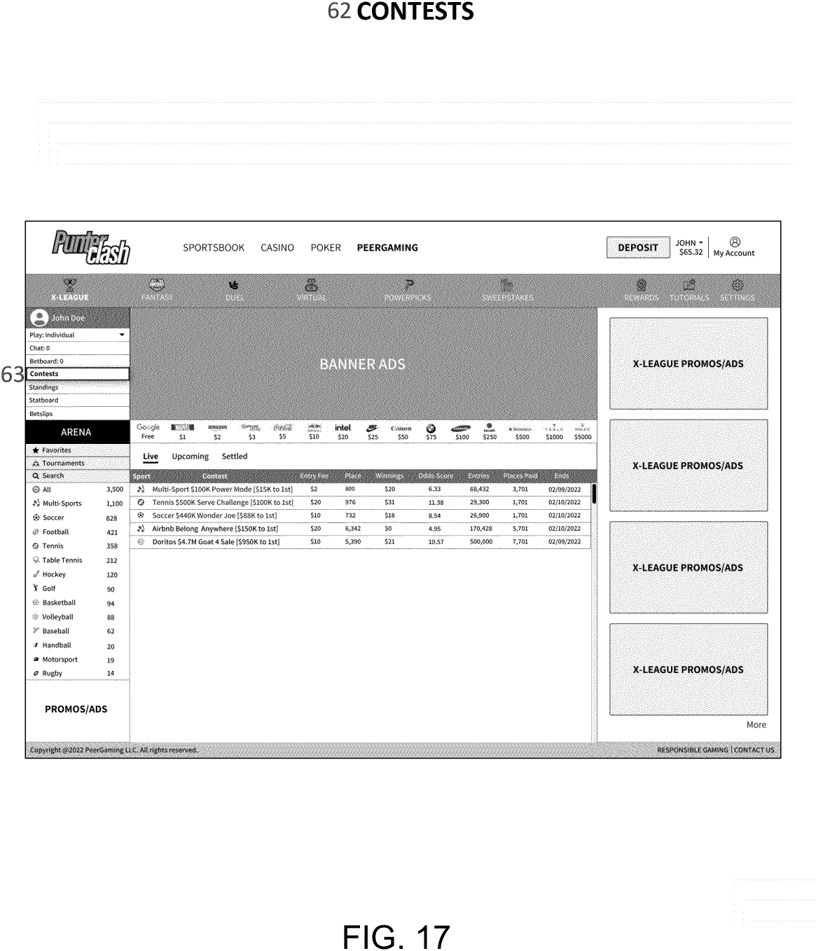

FIG. 18 shows another screen of the user interface for the sports betting system.

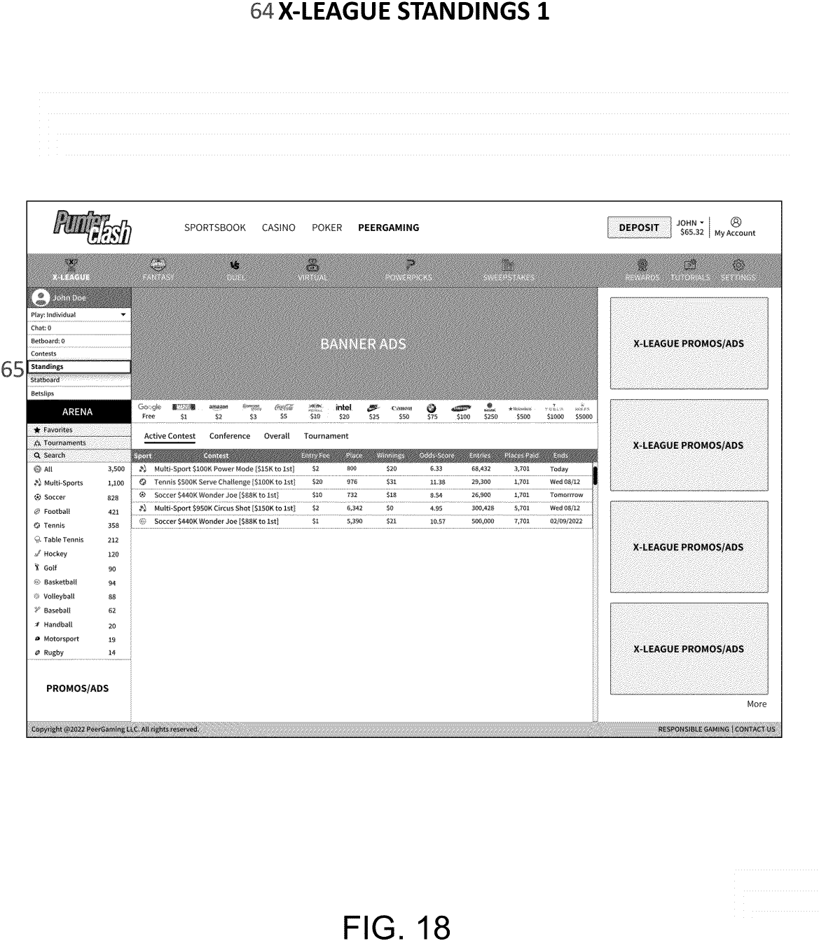

FIG. 19 shows another screen of the user interface for the sports betting system.

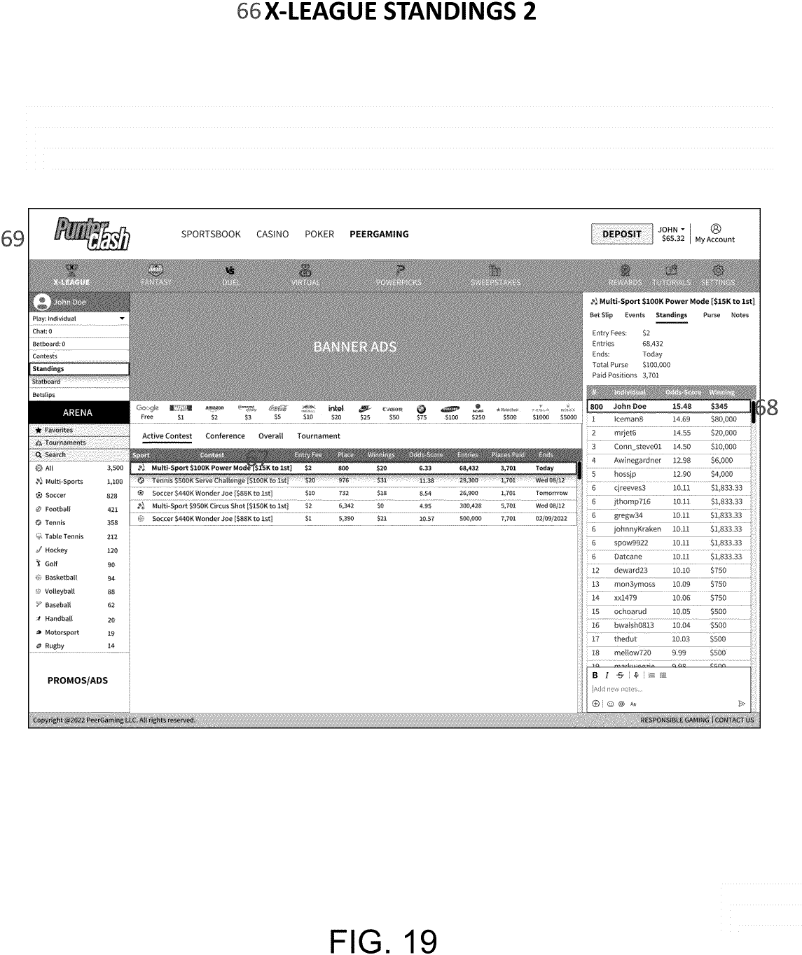

FIG. 20 shows another screen of the user interface for the sports betting system.

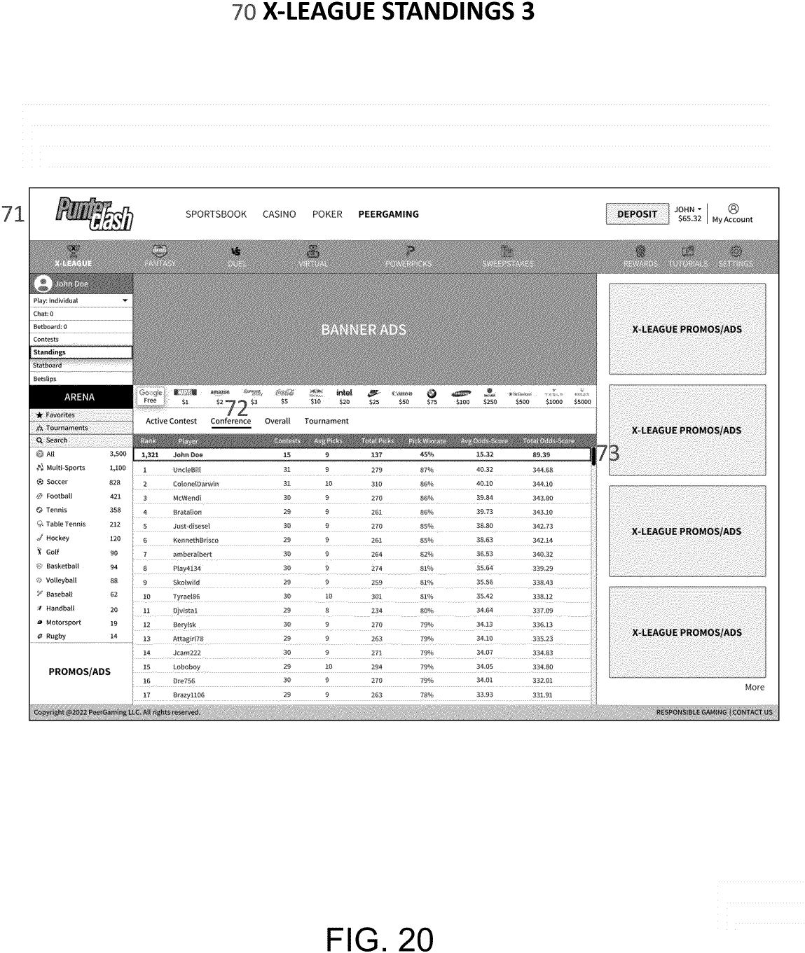

FIG. 21 shows another screen of the user interface for the sports betting system.

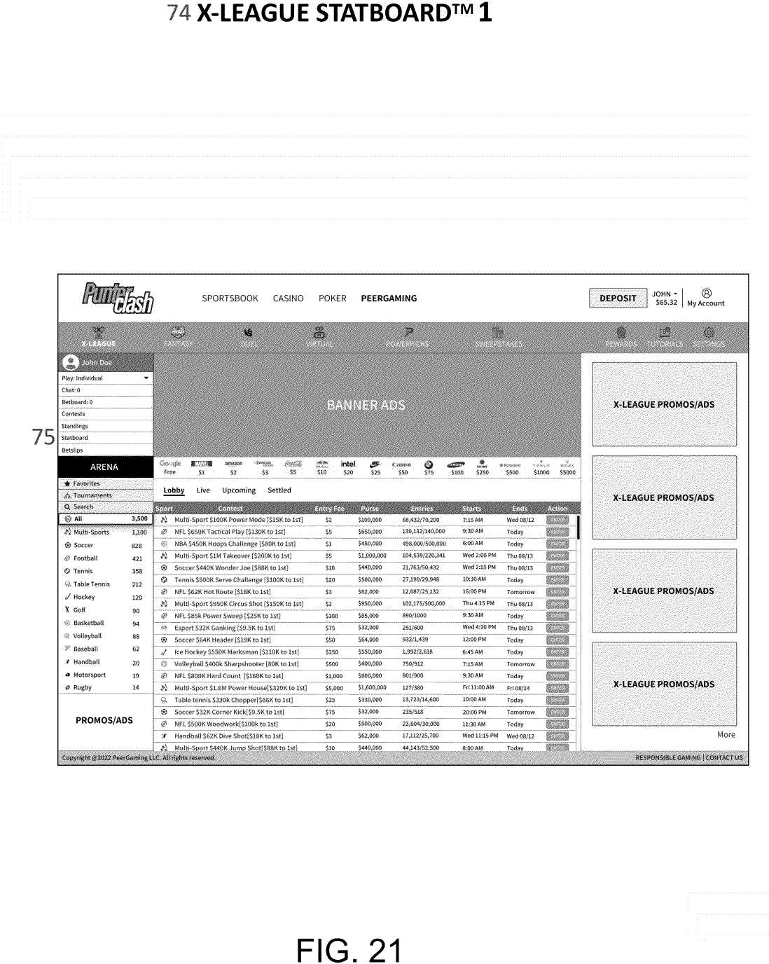

FIG. 22 shows another screen of the user interface for the sports betting system.

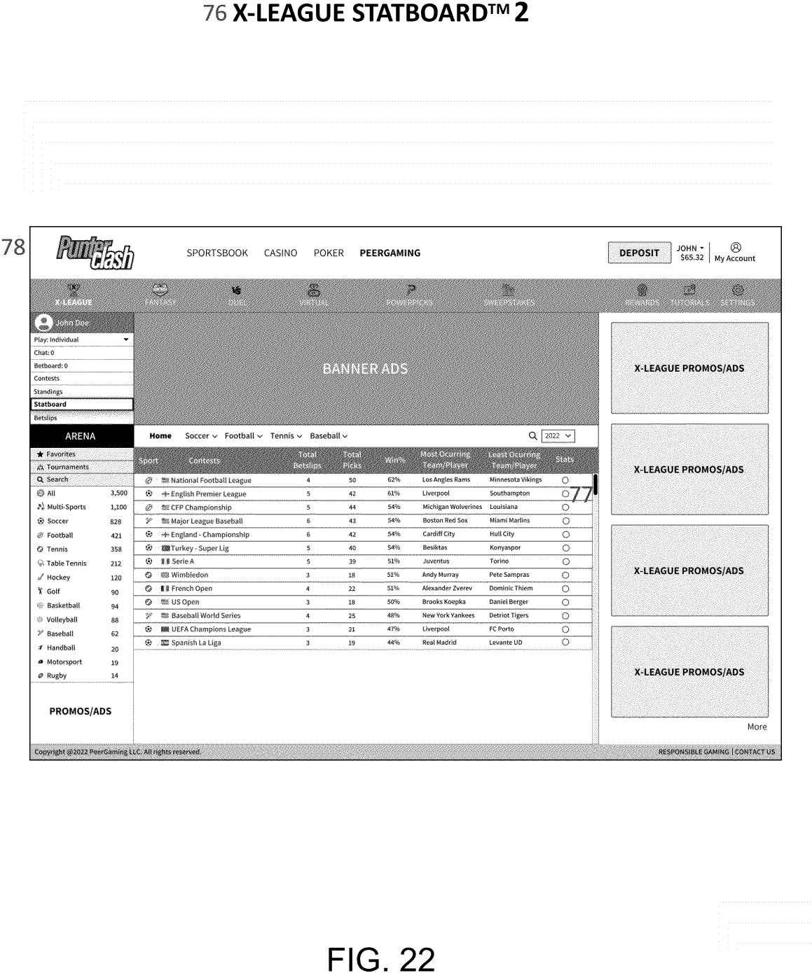

FIG. 23 shows another screen of the user interface for the sports betting system.

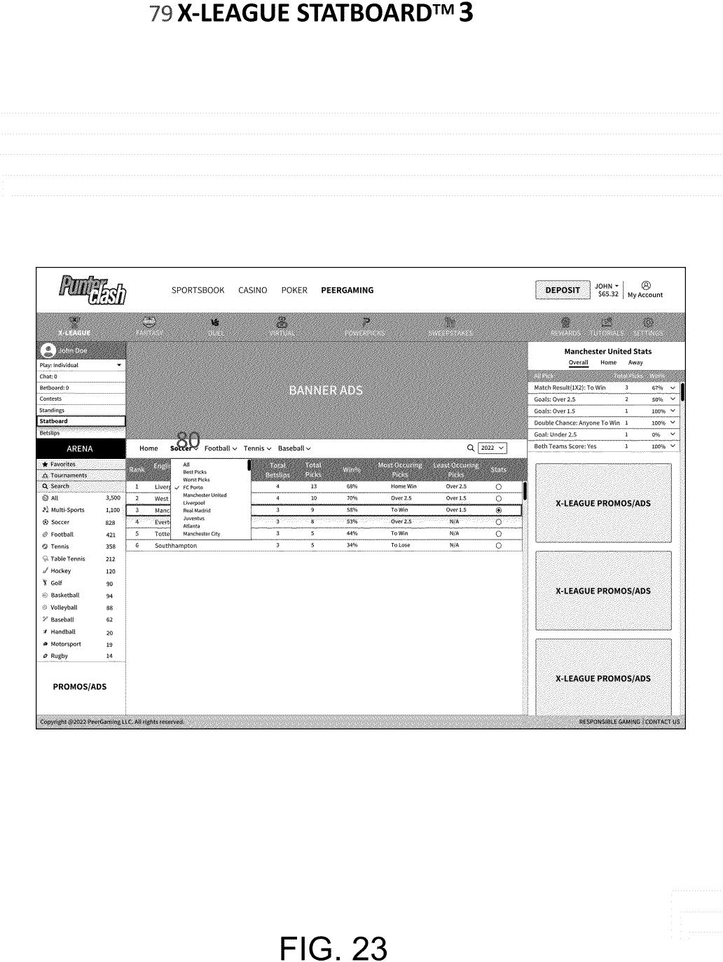

FIG. 24 shows another screen of the user interface for the sports betting system.

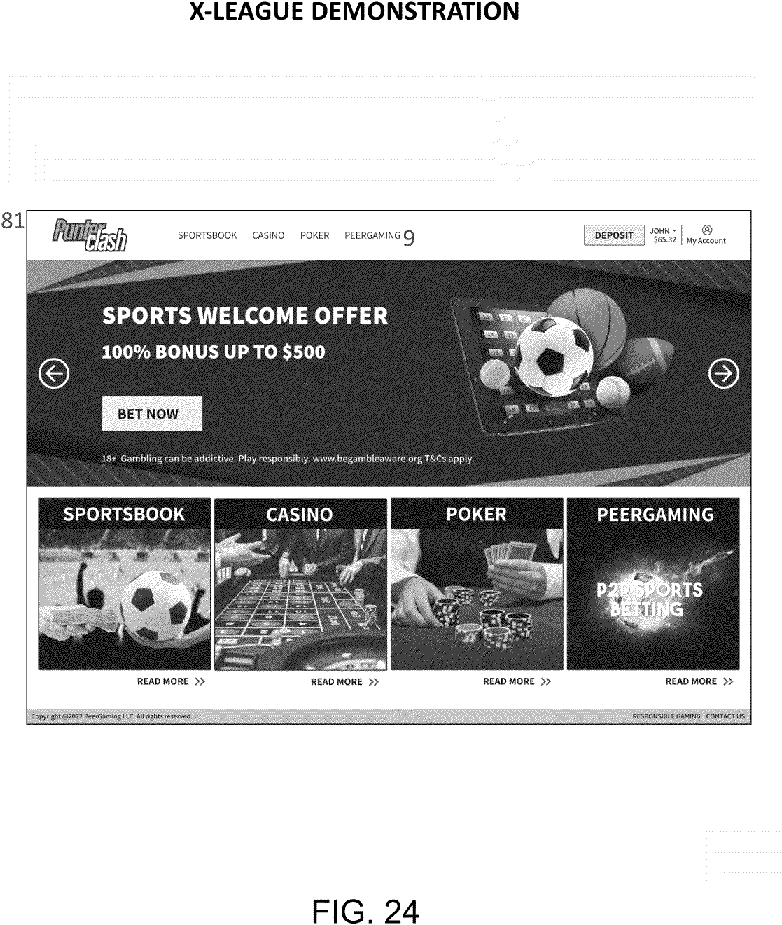

FIG. 25 shows another screen of the user interface for the sports betting system.

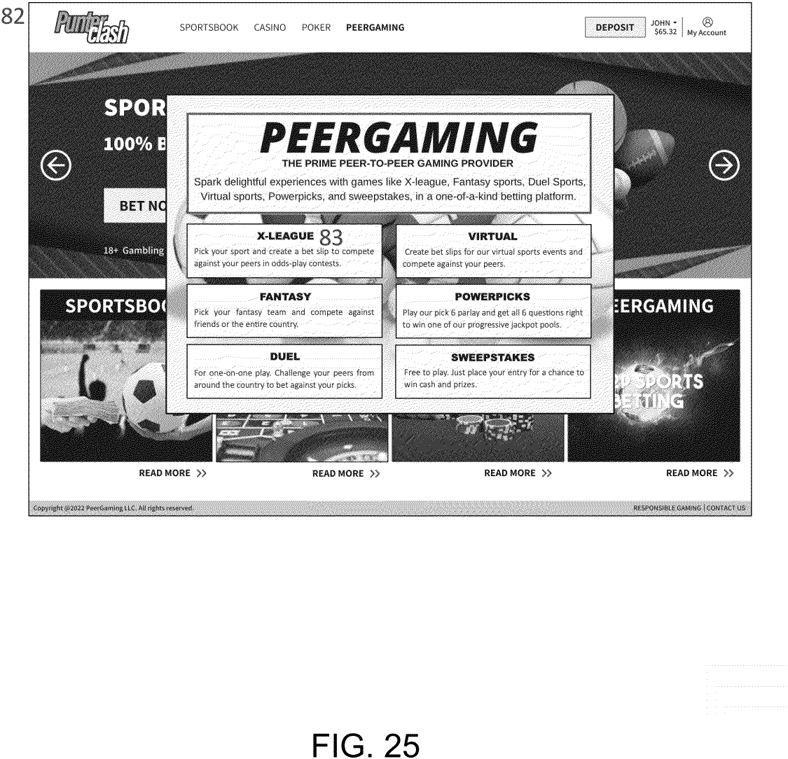

FIG. 26 shows another screen of the user interface for the sports betting system.

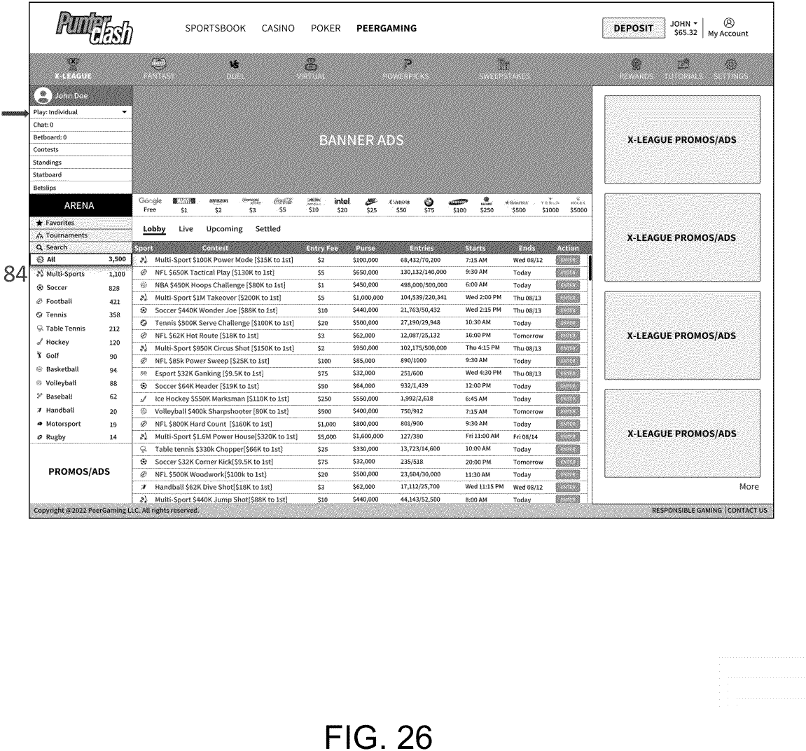

FIG. 27 shows another screen of the user interface for the sports betting system.

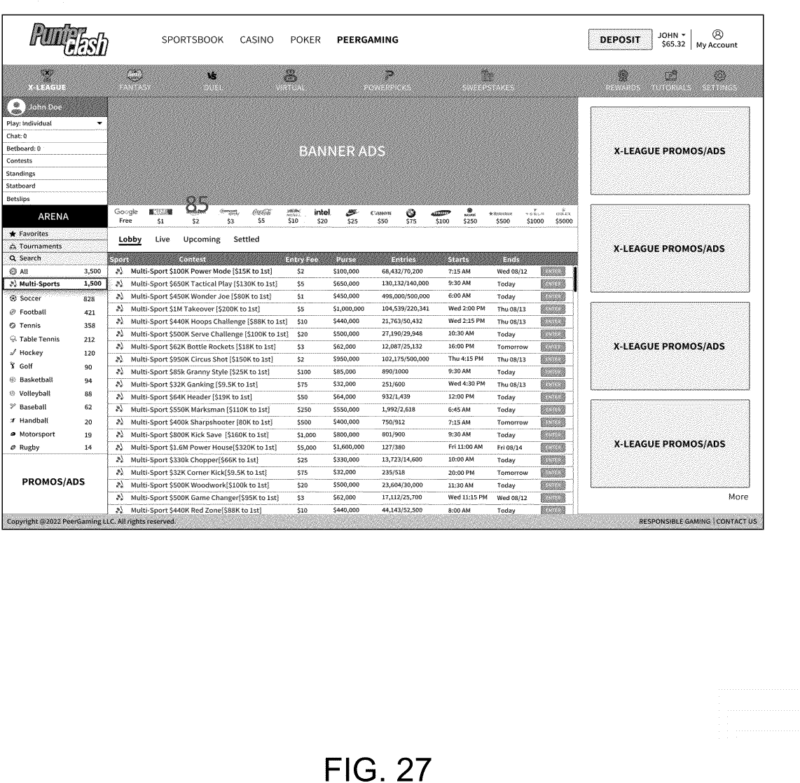

FIG. 28 shows another screen of the user interface for the sports betting system.

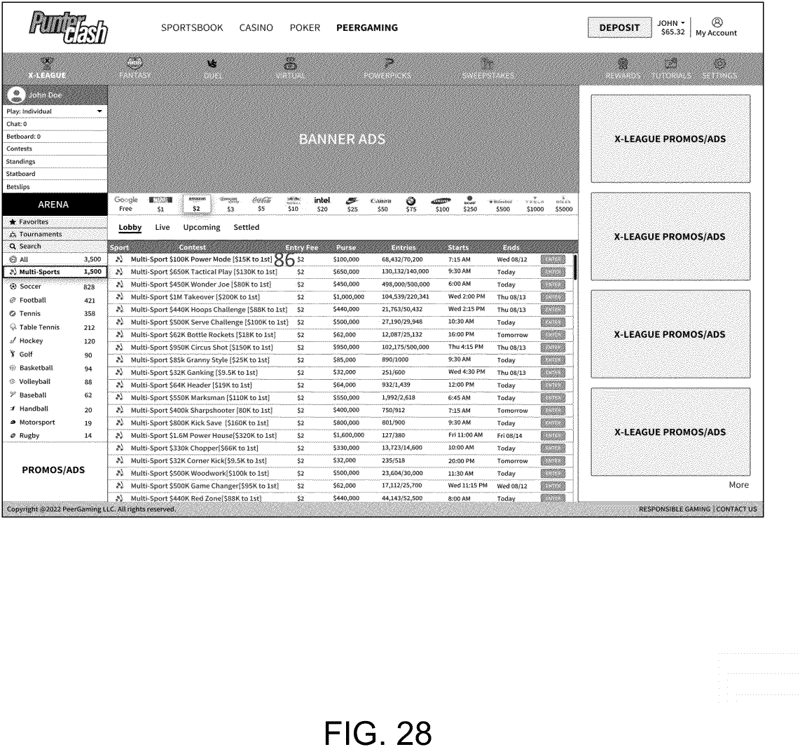

FIG. 29 shows another screen of the user interface for the sports betting system.

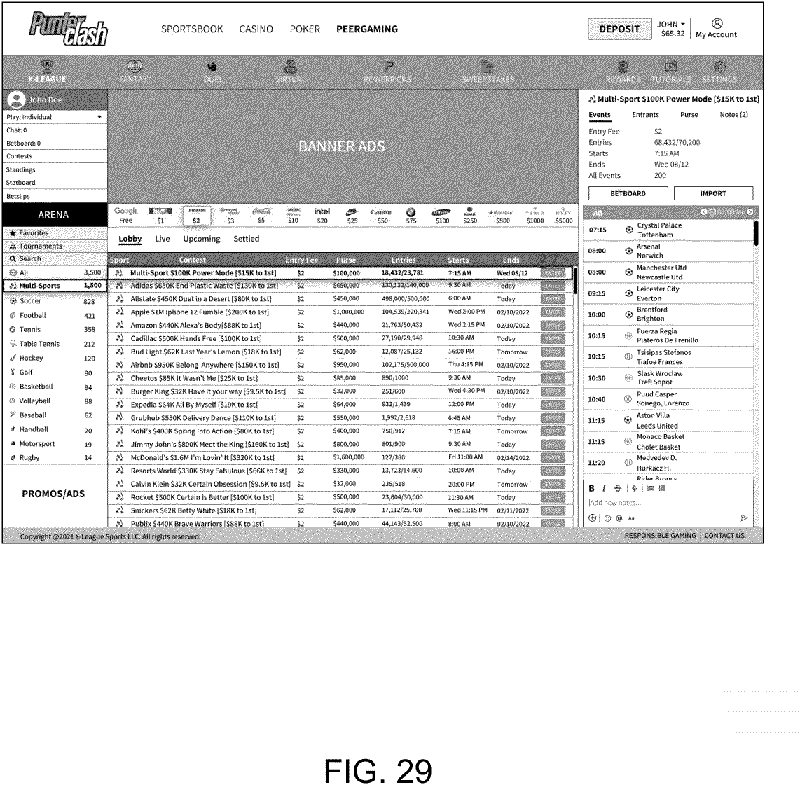

FIG. 30 shows another screen of the user interface for the sports betting system.

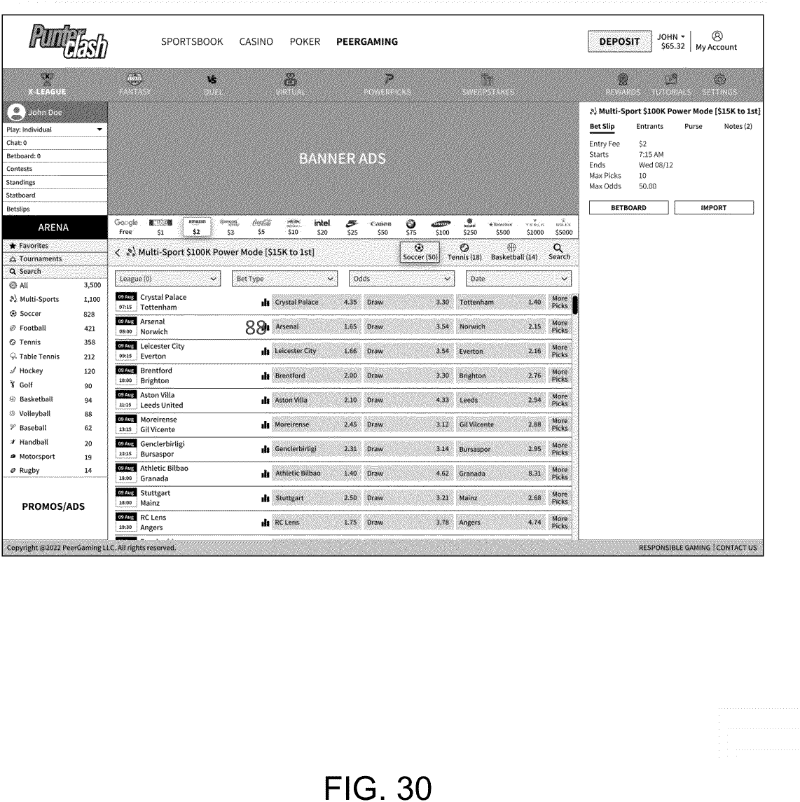

FIG. 31 shows another screen of the user interface for the sports betting system.

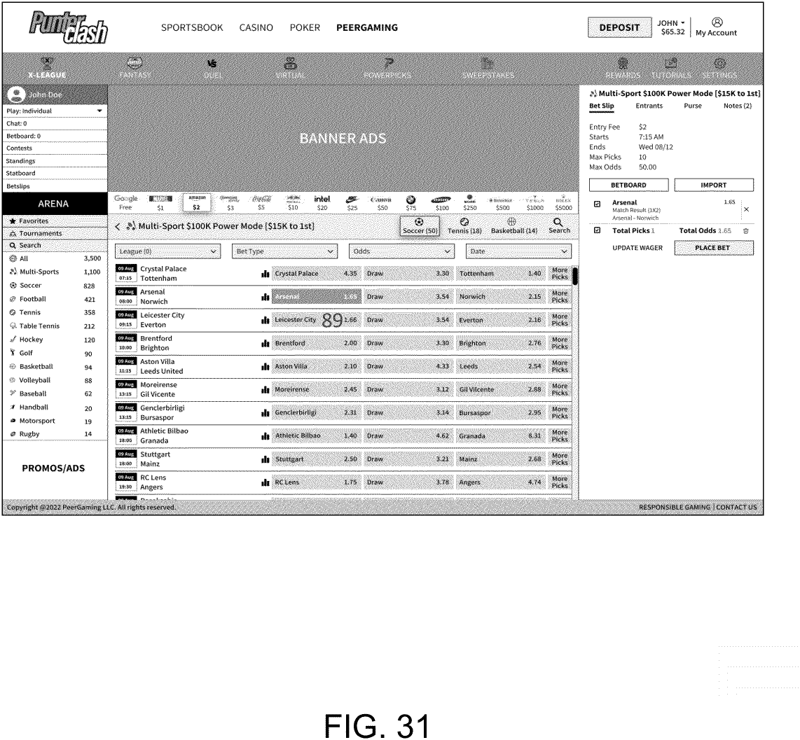

FIG. 32 shows another screen of the user interface for the sports betting system.

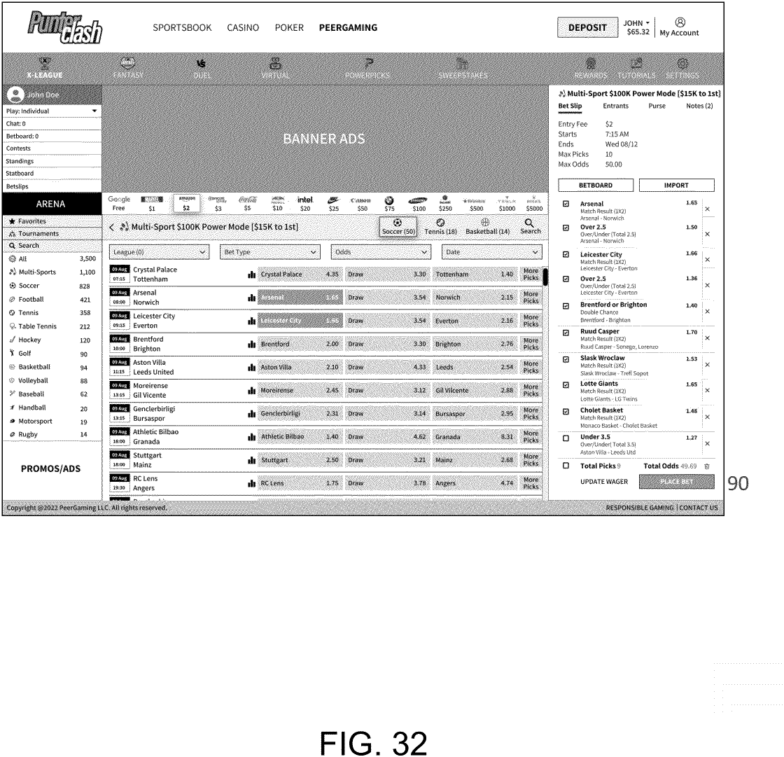

FIG. 33 shows another screen of the user interface for the sports betting system.

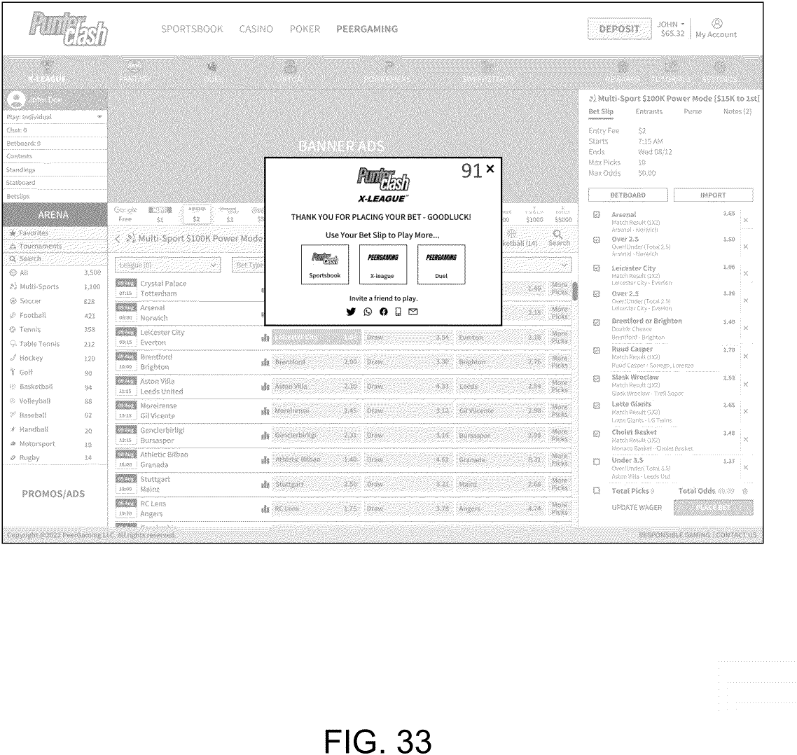

FIG. 34 show a screen of the tournaments or contest engine.

FIG. 35 shows another screen of the tournaments or contest engine.

FIG. 36 shows another screen of the tournaments or contest engine.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items” may indicate the presence of only one item or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skills in the art that the invention may be practiced without these specific details. In other instances, well-known features have not been described in detail to avoid unnecessarily complicating the description.

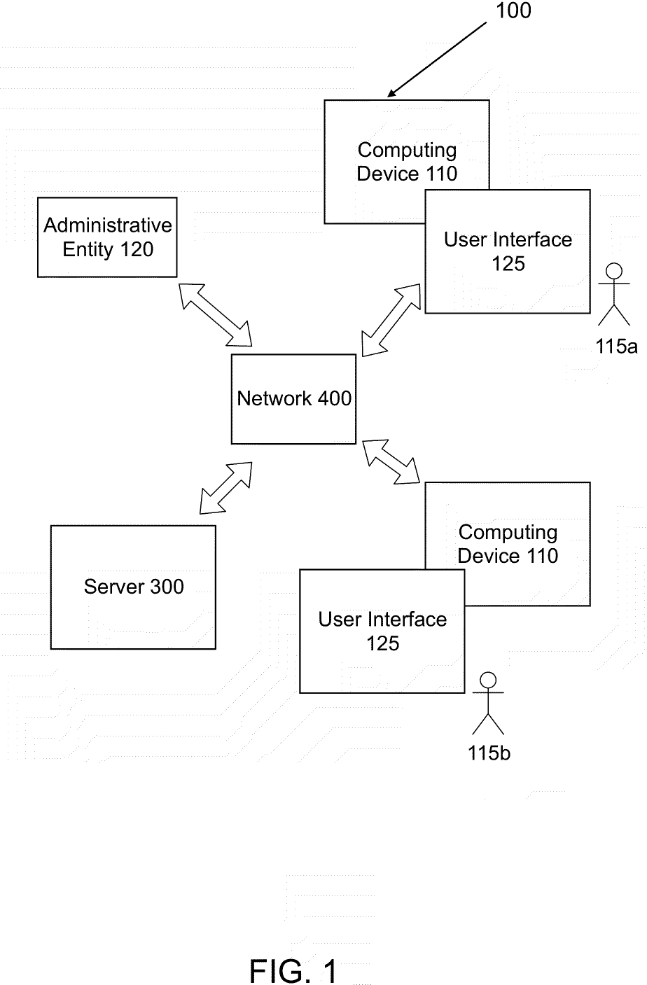

Turning to FIG. 1, FIG. 1 depicts a block diagram of an embodiment of the present invention for a sports betting system 100. Sports betting system 100. may include a plurality of computing devices 110. Computing devices 110 may be utilized by a series of users such as users 115, including user 115a and 115b, which may be sports bettors or other types of bettors. Further, computing devices 110 and users 115 may be located in various geographical locations that are either located apart or are located in proximity to each other. As used herein, the terms user and player may be used interchangeably. Computing devices 110 may have a user interface 125 for displaying content related to sports betting system 100 while allowing users to interact with sports betting system 100. User interface 125 may have a plurality of buttons or icons that are selectable through user interface 125 for sports betting system 100 to perform particular processes in response to the selections. User interface 125 may include but is not limited to a title bar, toolbars, pull-down menus, tabs, scroll bars, content help, dialog boxes, operating buttons (icons), and status bar that the user navigates throughout the display. The display appears in the browser window with the toolbar. Toolbar buttons activate the functionality. Toolbar buttons are active/inactive depending upon the tab and functionality presented in a view.

Computing devices 110 may be any type of computing device that typically operates under the control of one or more operating systems which control scheduling of tasks and access to system resources. Computing device 110 may be a phone, tablet, television, desktop computer, laptop computer, gaming system, wearable device, electronic glasses, networked router, networked switch, networked bridge, or any computing device 110 capable of executing instructions with sufficient processor power and memory capacity to perform operations.

In some embodiments, computing devices 110 may be in communication with one or more servers, such as server 300 via one or more networks such as network 400. Server 300 may be located at a data center or any other location suitable for providing service to network 400 whereby server 300 may be in one central location or in many different locations in multiple arrangements. Server 300 may comprise a database server such as MySQL® or Maria DB® server. Server 300 may have an attached data storage system storing software applications and data. Server 300 may have a number of modules that provide various functions related to sports betting system 100.

Modules may be in the form of software or computer programs that interact with the operating system of server 300 whereby data collected in databases as instruction-based expressions of components and/or processes may be processed by one or more processors within server 300 or another component of computing devices 110 as well as in conjunction with execution of one or more other computer programs. Modules may be configured to receive commands or requests from computing devices 110, server 300, and outside connected devices over network 400. Server 300 may comprise components, subsystems, and modules to support one or more management services for sports betting system 100. For example, server 300 may include modules operative to maintain presence information for one or more users 115 and to provide chat functionality allowing users 115 to communicate messages in a chat through sports betting system 100.

Servers 300 may have a control module with appropriate firmware or software and an operating system to control overall operation and configuration of sports betting system 100. The controller module may be in operable communication with a network interface module which provides interface functionality over one or more networks (wired or wireless) and possibly connectivity with other communication media. The controller module may also be in communication with an audio module and a video module, which receive and process audio and video data, respectively, from one or more connected video cameras or other input devices for users 115 on computing devices 110.

The audio module may include, among other modules or components for processing audio data, speech detection and recognition modules and codecs for processing incoming or outgoing video data. A speech detection module can be configured to detect instances of speech at a site (for example, to trigger recording or other functions of sports betting system 100), and/or determine the relative physical location of the detected speech for use in controlling the operation of individual microphones on computing devices 110. Speech recognition may be used to distinguish between individual voices for the purpose of filtering out other voices.

The video module may include image recognition modules for use in detecting speech or distinguishing between announcers or other individuals, and appropriate codecs for use in processing incoming or outgoing video data. The image recognition modules may include face tracking or pattern recognition algorithms to identify users 115. The audio and video modules may also include, respectively, interfaces for data communication between input units such as microphones and cameras, and output units such as speakers and display screens. The selection and implementation of appropriate speech and video modules, including codecs and speech detection/recognition modules, image recognition modules, including appropriate encoding, decoding, and compression algorithms, are those understood by those of ordinary skill in the art. Sports betting system 100 may also be equipped with security modules providing end-to-end security with other systems and intermediate host systems.

In one or more non-limiting embodiments, network 400 may include a local area network (LAN), such as a company Intranet, a metropolitan area network (MAN), or a wide area network (WAN), such as the Internet or World Wide Web. Network 400 may be a private network or a public network, or a combination thereof. Network 400 may be any type of network known in the art, including telecommunications network, a wireless network (including Wi-Fi), and a wireline network. Network 400 may include mobile telephone networks utilizing any protocol or protocols used to communicate among mobile digital computing devices (e.g., computing device 110), such as GSM, GPRS, UMTS, AMPS, TDMA, or CDMA. In one or more non-limiting embodiments, different types of data may be transmitted via network 400 via different protocols. In alternative embodiments, computing devices 110, may act as standalone devices or whereby they may operate as peer machines in a peer-to-peer (or distributed) network environment.

Network 400 may further include a system of terminals, gateways, and routers. Network 400 may employ one or more cellular access technologies including 2nd (2G), 3rd (3G), 4th (4G), 5th (5G), LTE, Global System for Mobile communication (GSM), General Packet Radio Services (GPRS), Enhanced Data GSM Environment (EDGE), and other access technologies that may provide for broader coverage between computing devices 110 if for instance they are in a remote location not accessible by other networks.

Sports betting system 100 may also include one or more administrative entities such as administrative entity 120. While administrative entity 120 is depicted as a single element communicating over network 400, administrative entity 120 in one or more non-limiting embodiments may be distributed over network 400 in any number of physical locations. Administrative entity 120 may manipulate the software and enter commands to server 300 using any number of input devices such as keyboard and mouse. The input/output may be viewed on a display screen to administrative entity 120.

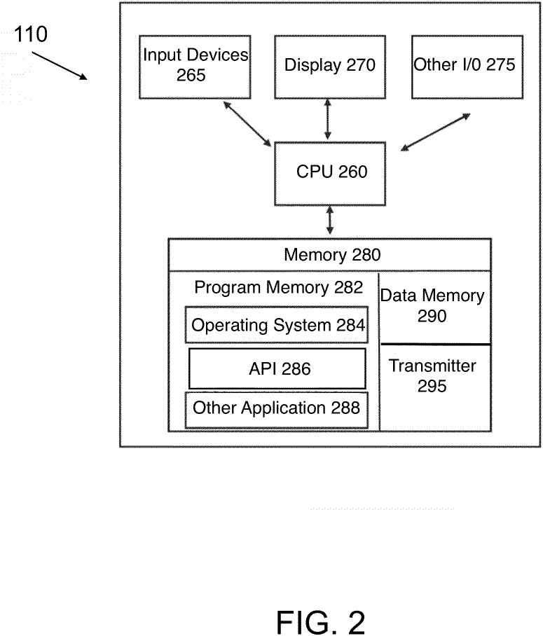

Turning to FIG. 2, FIG. 2 is a block diagram showing various components of a computing device 110. Computing device 110 may comprise a housing for containing one or more hardware components that allow access to edit and query sports betting system 100. Computing device 110 may include one or more input devices such as input devices 265 that provide input to a CPU (processor) such as CPU 260 of actions related to a user 115. Input devices 265 may be implemented as a keyboard, a touchscreen, a mouse, via voice activation, wearable input device, a camera, a trackball, a microphone, a fingerprint reader, an infrared port, a controller, a remote control, a fax machine, and combinations thereof.

The actions may be initiated by a hardware controller that interprets the signals received from input device 265 and communicates the information to CPU 260 using a communication protocol. CPU 260 may be a single processing unit or multiple processing units in a device or distributed across multiple devices. CPU 260 may be coupled to other hardware devices, such as one or more memory devices with the use of a bus, such as a PCI bus or SCSI bus. CPU 260 may communicate with a hardware controller for devices, such as for a display 270. Display 270 may be used to display text and graphics. In some examples, display 270 provides graphical and textual visual feedback to a user.

In one or more embodiments, display 270 may include an input device 265 as part of display 270, such as when input device 265 is a touchscreen or is equipped with an eye direction monitoring system. In some implementations, display 270 is separate from input device 265. Examples of display 270 include but are not limited to: an LCD display screen, an LED display screen, a projected, holographic, virtual reality display, or augmented reality display (such as a heads-up display device or a head-mounted device), wearable device electronic glasses, contact lenses capable of computer-generated sensory input and displaying data, and so on. Display 270 may also comprise a touch screen interface operable to detect and receive touch input such as a tap or a swiping gesture. Other I/O devices such as I/O devices 275 may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display may be used as an output device, such as, but not limited to, a computer monitor, a speaker, a television, a smart phone, a fax machine, a printer, or combinations thereof.

CPU 260 may have access to a memory such as memory 280. Memory 280 may include one or more of various hardware devices for volatile and non-volatile storage and may include both read-only and writable memory. For example, memory 280 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application programing interface (API), such as API 286, and other computerized programs or application programs such as application programs 288. Memory 280 may also include data memory such as data memory 290 that may include database query results, configuration data, settings, user options, user preferences, or other types of data which may be provided to program memory 282 or any element of computing device 110.

Computing device 110 may have a transmitter 295, such as transmitter 295, to transmit the data. Transmitter 295 may have a wired or wireless connection and may comprise a multi-band cellular transmitter to connect to the server 300 over 2G/3G/4G cellular networks. Other embodiments may also utilize Near Field Communication (NFC), Bluetooth, or another method to communicate information.

Users 115a and 115b may initially register to become a registered user 115 associated with sports betting system 100. Sports betting system 100 may be downloadable and installable on computing device 110. In one or more non-limiting embodiments, sports betting system 100 may be preinstalled on computing devices 110 by the manufacturer or designer. Further, sports betting system 100 may be implemented using a web browser via a browser extension or plugin. Server 300 may associate computing devices 110 with an account during the registration process.

Upon initially signing up with sports betting system 100, users 115 may be prompted to provide an email address. After entering an email address, users 115 may be presented with a text window interface whereby users 115 may enter their name, username, password, phone number, and address. In one or more non-limiting embodiments, location of users 115 may be verified by server 300 using the global positioning system (GPS) capabilities of computing devices 110 for verification to accommodate for various state legal systems. Server 300 then may generate a code that is transmitted to the user’s 115 selected email or computing device 110 by text message whereby users 115 may verify their account by entering the generated code into a text block window. Users 115a and 115b may be prompted to provide some personal information along with a requested account name and password, such as, without limitation, their name, age (e.g., birth date), gender, interests, contact information, home town, and address.

In some embodiments, when registering a user account, sports betting system 100 may allow users 115a and 115b to access and interact with sports betting system 100 using login credentials from other social networking platforms. For example, in some embodiments, it may be useful and convenient for users of sports betting system 100 to be able to log in using credentials or sign in information from another social media application, such as Facebook® or Instagram ® or the like. This is advantageous for users who do not wish to have to remember or provide multiple types of login information.

Users 115a and 115b may be requested to take pictures of themselves whereby server 300 collects and stores pictures of each user in a database to display to other users, for example, through user interface 125. Pictures may be for identification purposes during navigation of a session and to enhance the authenticity of the process by ensuring that the picture is of the correct, intended user 115 when interacting with other users 115. Users 115 may couple, link, or connect with user accounts from social networking websites and internal networks. Examples of social networking websites include but are not limited to Instagram®, Facebook®, LinkedIn®, Snapchat®, and Twitter®. Server 300 may use access tokens or other methods as a parameter for searching for a friend list or address book of users 115 on a social networking site or other site. Server 300 then may use this friend list information to initialize a contact list database for users 115 stored within server 300 databases.

Users 115 may opt-in for various sports betting system 100 notifications to be transmitted by server 300. Users may opt-in to allow sports betting system 100 to notify users when certain events occur, such as events related to other users 115 and any of their syndicates. In further embodiments, users may establish one or more different profiles.

In some embodiments, server 300 may generate notifications in the form of synchronization messages, such as an email message, text message, or calendar invitation for each user 115 related to the hot zones or special events causing the hot zones or special events to be included in a local personal information manager application connected to sports betting system 100, such as Microsoft Outlook and Google Calendar. In one implementation, the synchronization message may include a calendar data exchange file, such as an iCalendar (.ics) file in compliance with IETF RFC 5545.

In one or more non-limiting embodiments, users 115 may search for a syndicate to be associated with the intent of joining the syndicate whereby users 115 may create syndicate entries that can be used in tournaments or contests. Users 115 may also be presented options to create a syndicate of which other users 115 may join. The syndicates may come from an existing database stored on server 300 or a third-party database that server 300 is in communication with, whereby server 300 may receive results from a third-party connected database. User interface 125 may present to users 115 a search window whereby a search request having a character string may be entered, where one or more syndicates may be identified using name or other metadata pertaining to users 115 or friends of users 115.

As discussed, users 115 have the ability to create syndicates of invited users for the purpose of forming syndicate entries consisting of bets that can only be submitted by users within the syndicate. To start a group, a user 115 must invite users and users 115 must agree to join the syndicate. In some embodiments, users 115 may only join a syndicate if they are invited by an existing member of the syndicate. If syndicate members are to participate in monetized syndicate entries, they must be using the system while located in a geographic region where such forms of sports gambling are legal. Once a syndicate is formed, participants of the syndicate have the ability to start and join syndicate entries that are limited to players within the syndicate.

Users 115 may invite other users 115 or be invited by other users to connect to a syndicate via sports betting system 100. When one user 115 has a connection with another user 115 on a syndicate, the connected users 115 may be able to communicate with the other user 115 as well as receive the connected user’s 115 messages, picture, videos, and other content in the syndicate personalized content feed as well as video chat and texting chat communication utilizing the modules of server 300. In some embodiments, sports betting system 100 may automatically connect two users based on user specifications and criteria whereby a random syndicate may be created. Settings regarding communications by users 115 may be modified to enable the user to prevent the system from automatically connecting the user to another user or letting another user follow the user, or letting another user message the user, as well as other settings.

Sports betting system 100 enables user 115 to manage an existing bankroll. Users 115 add and withdraw money to their bankroll to ensure they have sufficient funds to cover their bets. Users 115 may be prompted through user interface 125 to input their credit card or debit card information for a credit card or debit card using any card known in the art, including, without limitation an ATM card, a VISA®, MasterCard®, Discover®, or American Express® card in a credit card input field, or can alternatively use PayPal®, Squarepay®, Cryptocurrency or the like. Once the transaction has been approved by the third-party payment facilitator, funds are added to the personal account of users 115 on sports betting system 100. If there are insufficient funds, a rejection may occur wherein the rejected transaction is logged in the databases of server 300 and users 115 may be presented with the rejection notice through user interface 125 wherein they may attempt another transaction. Once approved, a value corresponding to the funds may appear on the home page. In a similar manner, users 115 may withdraw funds to their credit cards or banking accounts or cryptocurrency accounts.

User interface 125 may provide the ability to obtain one or more images of the credit card associated with the financial transaction. Images of the credit card may be captured by camera on computing device 110 whereby sports betting system 100 may access the images. Images may include a front image of the credit card and back image of the credit card. Server 300 may collect and store pictures of one or more credit cards of each user in databases for subsequent use. In some embodiments, images and the extracted details of the credit card may be deleted from the memory immediately or shortly after a transaction has been completed or terminated, while in further embodiments, temporarily stored credit card data may be encrypted and compressed for added security and stored on databases for subsequent use whereby user interface 125 may allow users 115 to select from previously used credit cards.

Sports betting system 100 may utilize a blockchain module for the storage of transactions, the blockchain representing the completed transaction, whereby users 115, depending on the privacy settings, may view the complete history of betting for record keeping purposes. Construction and storage of a blockchain allows to quickly and efficiently validate or access data using a series of connected devices that record the same event or transaction, thereby improving the safety of transactions. The storage of the blockchain continues by obtaining a historical block identifier of the historical blockchain. Once the various pieces of information have been collected, a validity requirement based on the transaction may be calculated whereby if the validity requirements are met, the historical blockchain may be updated.

Upon successful registration, a home page may be generated by server 300 on user interface 125 using information stored on databases whereby the home page may be visible to user 115. Homepages may be modified, written to, or otherwise administered by their respective user 115 for customization. Administrative entity 120 may also modify or delete a home page, for example, as a result of inactivity or inappropriate action on the behalf of users 115.

The following describes reference numerals for the user interface which will be discussed.
1. Product Navigation: Select your desired game, X-League, Fantasy sports, e.t.c.
2. Dashboard: Select your type of play from an individual, team, “now syndicate,” or league. (Optional)
3. Arena: Filter to find your desired sports. (Optional)
4. Betbar: Filter to find your desired entry fee (Optional)
5. Lobby: Select a contest to preview its details (Optional)
6. Bet window: Preview contest details in the Bet window (Optional)
7. Click Enter: To create a contest bet slip, click the contest enter button.
8. How to place a bet: Page Title
9. Select PeerGaming: On any gaming operator’s platform, click PeerGaming to access its products.
10. Casino or sportsbook link: Page Title
11. Punterclash: A gaming operator brand name used for demonstrating PeerGaming’s concepts.
12. PeerGaming-Game options: Page Title
13. PeerGaming Landing page: Introduces PeerGaming’s game options
14. Main navigation: Page title
15. Main navigation: Snapshot of PeerGaming navigation bar
16. Dashboard 1: Page Title
17. Dashboard: Snapshot of the player’s primary control center
26. Dashboard 2: Page title
27. Play dropdown: To change the active play option from individual to team, “now syndicate” or league, click the dropdown.
28. Play dropdown result: Snapshot of display after clicking the play dropdown button.
29. Team “now syndicate” dropdown: View a player’s existing syndicates or create a new one.
30. Team “now syndicate” dropdown result: Snapshot of display after clicking the syndicate dropdown button.
31. Team “now syndicate” drop-up button: To minimize the syndicate view, click the drop-up button.
32. Arena: Page Title
33. Arena: Snapshot display of the sports and features contained in the Arena.
34. Tournaments 1: Page Title
35. Tournaments: Snapshot of how clicking tournament in the Arena displays all scheduled tournaments in the Lobby.
36. Highlighted tournament: Snapshot of how clicking a tournament name in the Lobby displays a tournament contest schedule in the betting window.
37. Tournament 2: Page Title (Continuation)
38. Tournament Contest dropdown: This shows the details of the events inside a tournament’s first contest round.
39. Click Enter: To create contest bet slips, click the tournament enter button.
40. Lobby: Page Title
41. Lobby: Snapshot display of the functions of a contest Lobby.
43. Betbar: Snapshot display of the Betbar sponsors and entry fees.
44. Bet window 1: Page Title
45. X-League promotions and sponsor ads: Displayed in the betting window.
46. Review contest events: Displayed in the betting window
47. Review contest entrants: Displayed in the betting window
48. Bet window 2: Page Title
49. Contest purse: Displayed in the betting window
50. Make or read contest notes: Displayed in the betting window
51. Betslip: Page Title
52. Review contest details: Displayed in the betting window
53. Posting a pick: Displayed in the betting window
54. Place final bet slip: Displayed in the betting window
55. Bet confirmation window: Page Title
56. PeerGaming Duel: No longer applies. Duel is simply tournaments.
57. Punterclash Sportsbook: Cross-play X-League contest bet slip to place a bet at Punterclash sportsbook.
58. X-League Betboard: Page Title
59. Betboard: Click to add an upcoming contest to the Betboard to review later.
60. Reserve: Pay entry fees for a contest inside the betboard to reserve an opportunity to submit a bet slip before a contest starts.
61. Notes(1): Click to preview contest notes inside the betboard.
62. Contests: Page Title
63. Dashboard Contests: Click contests inside the dashboard to access the live, upcoming, and settled states of a player’s contests.
64. X-League standings 1: Page Title
65. Dashboard Standings: Click standings inside the dashboard to access live contests, conferences, and tournament standings.
66. X-League standings 2: Page Title
67. Highlighted contest: Click a contest name to preview its standings inside the betting window.
68. Active user’s standings: Displays the rank of an active user before every other user.
69. Snapshot of live contest standings.
70. X-League Standings 3: Page Title
71. Snapshot of conference standings.
72. Conference Standings: Click the Betbar to navigate the conference submenu.
73. Active User rank: Displays the rank of an active user before every other user.
74. X-League Statboard 1: Page Title
75. Dashboard Statboard: Click the statboard inside the dashboard for insights on picks stats performance.
76. Dashboard Statboard 2: Page Title
77. Stat checkbox: Click the checkbox for more stats on performance in any sports league.
78. Snapshot of statboard home
79. X-League Statboard 3: Page Title
80. Highlighted Soccer: Clicked to see the list of teams from which a player has made previous soccer picks.
81. Punterclash landing page: Exhibits the platform of a gaming operator that carries PeerGaming products.
82. PeerGaming Landing page: Introduces PeerGaming’s game options
83. Select X-League: Click X-League from the available games to play X-League.
84. Select Multi-sports: Click multi-sports inside the Arena to find all contests that allow mixed sports event selections (optional)
85. Select Amazon conference: Click the amazon logo inside the Betbar to find all $2 contests (optional)
86. Select contest name: Click a contest name to preview its event details inside the betting window.
87. Click Enter: To create a contest bet slip, click the contest enter button.
88. Select Arsenal 1.65: Click to add odds prediction into the bet slip
89. Select Leicester City: Click to automatically fill up the bet slip within the constraint of 50 maximum odds and ten picks
90. Select place bet: Click to submit the bet slip for peer-to-peer competition.
91. Select the “x” button: Click to remove the bet confirmation window
92. X-League Play Engines: Page title
93. Illustration of an individual X-League contest
96. Illustration of a team “now syndicate” X-League contest
101. Specifications of a head-to-head tournament structure for X-League

The home page may include a number of different subpages viewable or accessible by selecting one or more tabs presented on user interface 125. When viewing the home page on user interface 125, users 115 may select X-League where a user 115 enters a contest to create a bet slip to compete against one or more other users 115 in a peer-to-peer contest, Virtual where users 115 may create betting slips for virtual sports events and compete against other users 115, Fantasy where users 115 pick fantasy teams and compete against other users 115, Power picks where users pick a parlay with six outcomes to win a progressive jackpot pool, Duel where users 115 compete in one on one play in a bracket-style game tournament, and Sweepstakes that is free to play where users 115 compete for a chance to win free sponsored prizes.

A dashboard may be presented onto user interface 125 acting as primary control center for personal content, betting play, and communications. Dashboard may present the individual or Syndicate ID currently selected, whereby a drop-down menu may appear where users 115 may switch between their individual profile or existing syndicate profiles. Users 115 may view any chats, texts, or video conversations between syndicate members or other users 115. Users 115 may view a betboard where they may review or make notes on upcoming contests, allowing for convenient research and customization when creating betting slips. Users 115 may view their current standings in active tournaments or other competitions. Users 115 may view their individual and syndicate betting selections statistics including how each user 115 in the syndicate is performing. Users 115 may view their individual and syndicate betting selections history.

As discussed, the dashboard may include a chat tab for displaying a chat messaging interface to users 115. In one or more non-limiting embodiments, the chat messaging interface displayed to users 115 has controls through user interface 125 that allow users to establish a chat session with second users 115. After selecting the chat tab, users 115 may also be presented with a list of current chats with other users 115. Different options may be presented for users 115 within the same syndicate including a chat room for just syndicate members whereby users 115 may be placed in a video conference or a chatroom to discuss strategy for future bets or other topics.

An arena window 32 may be presented through user interface 125 whereby users 115 use it to filter the lobby 40 for the type of sports they want to bet on. Users 115 can even save their favorite teams or players for easy instant search to the upcoming contests they are in. A selectable filter button for tournaments on the arena window 32 may be presented whereby users 115 may see what tournaments are available for playing. Once user 115 sees a tournament they wish to participate in or inquire for more information on, they may select the tournament name to review contest details 145.

Tournaments and contests may also be selected by any number of parameters such as but not limited to the entry fees of the tournament or contests, the types of sporting events and the provided odds markets, the start and end date, the prize-paying structure, the available and/or maximum Users 115 entries, and the maximum payout. The tournament contest drop-down allows Users 115 to view a subset of sporting events available inside tournament contests rounds. Tournament system 100 may utilize X-League proprietary play engines to resolve contests. Furthermore, tournaments and contests may span any number of sporting events or games or time intervals, including but not limited to a week or an entire season.

User interface 125 may have a proprietary X-LEAGUE BETBAR which organizes contests according to the entry fee. A user 115 may click on a preferred conference through user interface 125 to display upcoming contests for the entry fee listed under each sponsor’s logo. Once user 115 has determined which tournament or contest they wish to participate in, users may be presented with a plurality of sporting events and outcomes, including but not limited to futures, money line props, point props, player props, over/under, and other odds markets.

Users 115 total number of picks and Odds-Points in one specific category must be less than or equal to Max-Odds (50) and 10 Max-Picks. However, this is non-limiting and may vary depending on the contest or tournament. In another non-limiting example, Users 115 may select a tournament or contest in X-league where they may participate as an individual or a syndicate.

Once Users 115 decides to participate in a tournament or contest from their individual profile, they click the contest enter button and begin picking sporting events odds to fill up their betting slip, Users 115 may be notified of the increasing value of their total betting slips odds as they add new sporting events odds, the value of each event odds, average selected odds value, and any fluctuations in odds chosen value, so they may immediately decide whether to have a specific event odds remain in their betting slip or have it removed. The betting slip remains open for users 115 to add or remove event odds until they click the place bet button 90. After users 115 decide on their final picks, the number of selections and total odds points displayed close to a place bet button must be less than or equal to the 50 Max odds and 10 Max selections for the betting slip to be accepted.

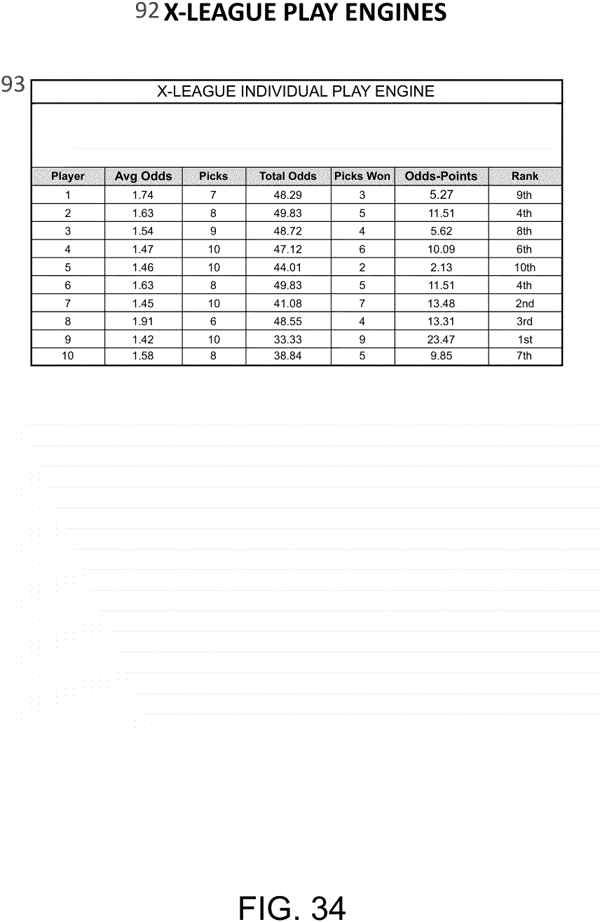

A sample contest is illustrated in FIG. 34 with a contest having 10 participants whereby all users 115 strategically make their picks to get close to a max odds of 50 and maximum selections of 10. Column 1 shows the number of users 115 in the contest. There are no limitations on the maximum number of users 115 in a contest, but a contest operator may introduce limits to manage contest operations. Column 2 illustrates the average of the two or more odds selected by users 115. While making picks, users 115 may choose any available odds from 1.01 to 50.00, giving each user 115 the freedom to choose any odds value that suits their preference. For instance, table 93 shows player nine accumulated low-valued odds while player eight chose high-valued odds.

Column 3 shows the number of picks. The number of selections is dependent on their average odds. For example, any average odds above 1.47 would exceed the maximum odds of 50; hence users 115 will need nine or fewer selections to be accepted into a contest. Column 4 shows the total odds users 115 submitted for the competition. The value of the total odds users 115 present in a contest is the maximum odds points they can score in a contest or tournament. Column 5 shows the number of picks won by users 115. Losing picks reduce users 115 total odds, and every winning selection increases the chances of finishing in a prize-paying position. Column 6 shows the odds points users 115 won out of their initial total odds. The winning odds point is used to determine a player’s position. When two or more players tie in a place, the related pool positions will be evenly split among each player. Column 7 shows the ranking of winning odds points in descending order. Server 300 may then determine one or more winners based on their rank.

In some embodiments, two or more users 115 on the syndicate must satisfy the payment condition for contest entries. In other embodiments, users 115 may start a syndicate and define the parameters for membership or join an existing syndicate created by another user 115. In other embodiments, one or more syndicate members may submit a betting slip for a syndicate contest entry, whereby only users 115 on the syndicate that satisfies the payment condition for the contest are rewarded with a share of winnings. This may be a good option for a group of users 115 that may like to participate in many contests but need the help of other users 115 to bear the risk of losing.

Starting a syndicate profile allows users 115a to specify the settings for their syndicate membership. In this instance, a user 115, known as the syndicate manager, may decide to keep and/or share authority with other users 115 to decide on the tournament or contest the syndicate should play. A syndicate contest or tournament entry begins when a syndicate manager or an authorized user 115 of a syndicate adds the contest or tournament to the syndicate betboard 59 or submits a betting slip into the contest or tournament. A Betboard 59 helps each user 115 of a syndicate to contribute a betting slip or share notes with other syndicate users 115 on an upcoming contest. The system and method make each syndicate member’s betting slips available for other users 115 to see. Users 115 of a syndicate are notified as 115 betting slips are added and removed from the syndicate betting slips awaiting submission. A syndicate’s one or more betting slips remain open for editing until a designated number of users 115 have agreed and can satisfy the payment conditions for contest entry fees. The syndicate manager or authorized user 115 makes a syndicate final contest submission. Users 115 that present a betting slip for a syndicate contest entry are required to satisfy the payment condition for a syndicate contest entry.

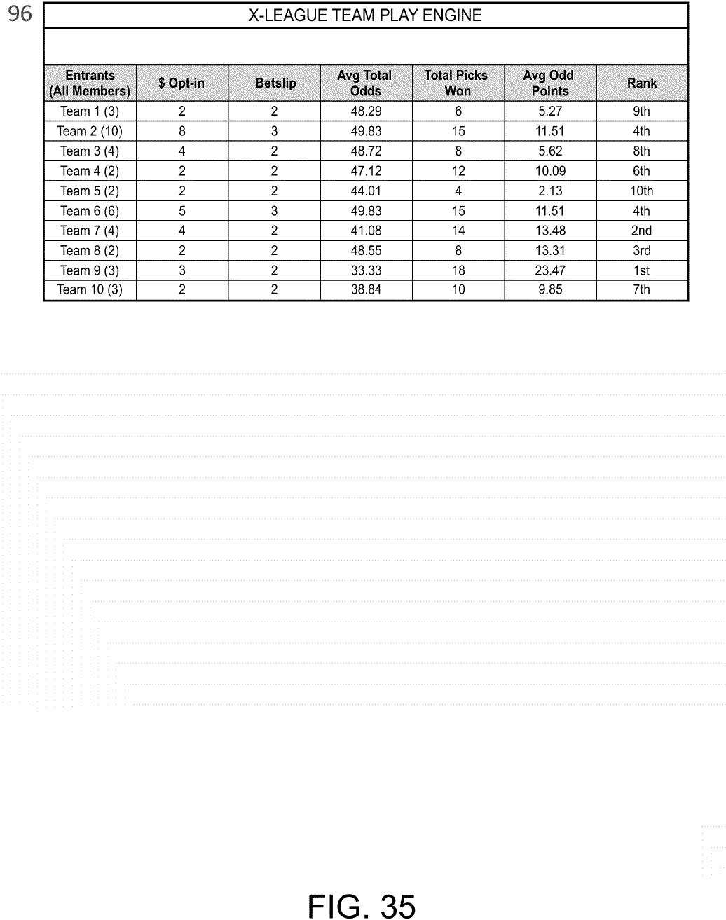

Another sample contest is illustrated in FIG. 35 with a syndicate contest having 10 participants whereby all users 115 strategically make their picks to get close to a max odds of 50 with a maximum number of selections of 10. There are no limitations on syndicate contest entrants unless constraints are applied to manage contest operation. At least two syndicate members must contribute an entry fee for a contest. Only members contributing their share of the entry fee are eligible to share contest winnings. Only one or more syndicate users 115 are required to submit betting slips for a contest, while the other users 115 may contribute a share of entry fees without submitting a bet slip. The syndicate manager is responsible for choosing a contest or tournament for his syndicate users 115 as well as given control of the team. When two or more users 115 of a syndicate submit betting slips for a contest, the average of the total odds of their betting slips is used to determine their entry total odds. The average of the total winning odds from each betting slip when two or more syndicate members submits a betting slip is used to determine the syndicate ranking odds point. Once server 300 determines a syndicate rank in a prize-paying position, funds are disbursed to users 115 on the syndicate who created betting slips or other users 115 who paid the entry fee but did not create a betting slip or the overall team in a different fund.

Another embodiment is a bracket-style tournament betting system similar in bracketing to US7682251, which is incorporated by reference. The present invention has a significant distinction between both systems in how contest rewards are determined. This tournament format allows for the right balance of skill versus luck for users 115, who may be either casual or sharp players. The tournament format matches users 115 head-to-head against any other player within the same contest bracket. The first tournament round has a single bracket, and each next tournament round has a winners bracket and a losers bracket emanating from the outcomes of the last tournament round. The systems and methods of this tournament model require three or more tournament rounds; however, this is non-limiting and may be any number of rounds. This embodiment determines reward by ranking precedence to the descending order of users 115 that won the most tournament rounds. The descending order of the cumulative score or points from one or more tournament rounds is used afterward to determine the final tournament ranking.

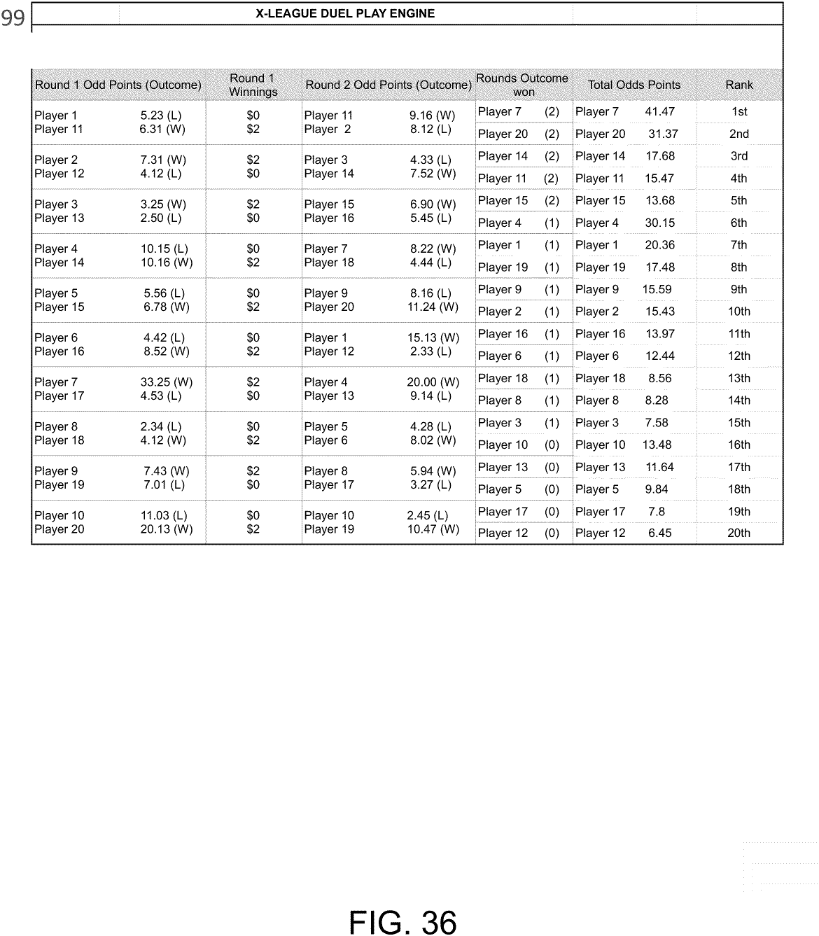

Another sample contest or tournament is illustrated in FIG. 36 which demonstrates a tournament with a $2 entry fee and 20 participants. In this tournament, all players compete head-to-head in two rounds of play for each tournament that may be randomly assigned or predesignated based on previous rankings our outcomes. The goal is to outsmart opponents in a head-to-head contest. In the first round, players have paired automatically for a head-to-head contest. The tournament requires an even number of users 115. A tie between two users 115 is considered a win for both users 115, and both participants get back their entry fee. There are no limitations on tournament entries unless constraints are applied to manage contest operations. Tournament round winners often get back their share of each contest round entry fee, whereby the round loser’s entry fee goes towards the overall tournament purse. In tournament table 99, column 6 shows player seven ranked 1st for winning two tournament rounds and scoring the most cumulative tournament rounds winning odds. Even though player ten almost had the same cumulative winning odds as player 16, their rank differed significantly due to the number of tournament rounds won. Rank highly depends on the total number of rounds a player wins. The total odds point which may be added up is used to determine a player’s overall position. After the designated tournament contests have been completed, the sports betting system 100 determines and assigns ranking from the values of total rounds won from most to least number of opponents and cumulative winning odds from all rounds.

Users 115 may also be rewarded with game achievements based on mastering certain in-game facets. As used herein, “reward” refers to a graphical, audio, numerical, or other player notification event that occurs. A reward may be a positive indicator of accurate gameplay, such as an accrual of points or ranking, an indication of advancing to the next level that may be presented to other users 115. Server 300 may calculate and disburse payments or trophies as rewards to users fulfilling requests, whereby sports betting system 100 may indicate the payment to be provided to user 115 if user 115 performs a task or is selected for sports betting system 100 provides payment to user 115.

In some embodiments, server 300 may analyze and calculate data stored in the databases whereby user interface 125 may display collected results from server 300 in the form of ranking leaderboards among the users 115 based on any number of parameters, including most wins in the month, most bets, most money won, and other rankings whereby sports betting system 100 may further incentivize users 115 on the leaderboards with advertisements, promotions, or notifications directed to attracting other users 115.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A sports betting system for plurality of sports bettors; comprising:
a computing system having a non-transitory computer-readable medium, the computing system having one or more processors coupled to one or more databases over a network, the computing system having a communications network that enables communications between a plurality of computing devices including a first computing device and a second computing device; the computing system having a memory coupled with and readable by the one or more processors and storing therein instructions that, when executed by the one or more processors, wherein the sports betting system performs steps to:
receive, over the communications network, a plurality of sports betting slips having a plurality of selections of one or more sports events from the plurality of computing device, wherein the plurality of selections includes odds selections and define an outcome associated with the one or more sports events, wherein the plurality of sports betting slips are in different formats;
standardize the different formats for a contest into a standardized format such that the plurality of sports betting slips are comparable to one another in the contest;
compare results of the plurality of betting slips by the plurality of computing devices in the contest in the standardized format; and
rank the plurality of sports betting slips in response to descending order of results of the plurality of sports betting slips in the standardized format ; and
transmit the ranking of the plurality of sports betting slips in real time, over the communications network, to the plurality of computing devices .

2. The sports betting system of claim 1, transporting the plurality of sports betting slips into a second contest in the different formats without having to reapply the plurality of selections to the plurality of sports betting slips.

3. The sports betting system of claim 1, wherein the sports betting system performs steps to: set a maximum odds of which the plurality of selections cannot exceed.

4. The sports betting system of claim 3, wherein the sports betting system performs steps to: set a maximum number of the plurality of selections.

5. The sports betting system of claim 3, wherein the maximum odds is 50.

6. The sports betting system of claim 4, wherein the maximum number of the plurality of selections is 10.

7. The sports betting system of claim 3, wherein the sports betting system performs steps to create a plurality of different contests or tournaments.

8. The sports betting system of claim 7, wherein the plurality of sports bettors are subdivided based on a tier system wherein a tier prevents the plurality of sports bettors from accessing the plurality of different contests or the tournaments.

9. The sports betting system of claim 7, wherein the sports betting system performs steps to: present a bar which organizes the plurality of different contests or tournaments according to an entry fee with a sponsor above the plurality of different contests or the tournaments.

10. A sports betting system for a plurality of sports bettors, the sports betting system comprising:
a computing system having a non-transitory computer-readable medium, the computing system having one or more processors coupled to one or more databases over a network, the computing system having a communications network that enables communications with a plurality of computing devices including a first computing device and a second computing device; the computing system having a memory coupled with and readable by the one or more processors and storing therein instructions that, when executed by the one or more processors, wherein the sports betting system performs steps to:
create a syndicate in response to a syndication creation request from a first account on the first computing device;
transmit, over the communications network, an invitation from the first computing device to a second account on the second computing device to join the syndicate, the second computing device separate from the first computing device;
associate the second account on the second computing device with the syndicate in response to an approval of the invitation;
receive a plurality of possible predictions of one or more sports events from the first computing device and the second computing device to create a syndicate betting slip, wherein the plurality of possible predictions on the syndicate betting slip are only submittable is by syndicate members wherein the one or more possible predictions includes odds selections and define an outcome associated with the one or more sports events;
notify, over the communications network, the first computing device and the second computing device of addition or removal of one of the plurality of sports betting predictions on the syndicate betting slip;
submit the syndicate betting slip for a contest;
standardize a format of the syndicate betting slip into a standardized format for the contest for equal comparison;
assign an average of total odds of the syndicate betting slip submitted by the first account on the first computing device and the second account on the second computing device for a contest to entry odds associated with the syndicate;
compare average results of multiplication of winning odds of the one or more sports events on the syndicate betting slip submitted by the syndicate and one or more second syndicate betting slips from one or more second syndicates;
rank the average results from the syndicate betting slip and the one or more second syndicate betting slips in descending order
determine a payout based on the plurality of sports betting slips rankings and transmit the payout to the first account on the first computing device and the second account on the second computing device.

11. The sports betting system of claim 10, wherein the sports betting system performs steps to: determine a location of prospective syndicate members authentication for determining if the first account and the second account can legally join the syndicate based on a jurisdiction.

12. The sports betting system of claim 10, presenting a digital board on a user interface on the first computing device and the second computing device for reviewing and commenting on the syndicate betting slips by the syndicate members.

13. The sports betting system of claim 12 wherein maximum odds for the plurality of sports betting slips is 50.

14. The sports betting system of claim 13 wherein a maximum number of one or more possible predictions is 10.

15. The sports betting system of claim 10, wherein the sports betting system performs steps to: assign control of contest entry permissions to a syndicate manager; assign the control of sending syndicate membership invitations to the syndicate manager; and send the syndicate membership invitations in response to searching for and detecting a presence of prospective sports bettors from the sports betting system.

16. The sports betting system of claim 10, wherein the sports betting system performs steps to: changing an active play option on a display of the plurality of computing devices between individual betting to syndicate betting for differentiation; and
transporting the syndicate betting slip into a second contest in original format without having to reapply the plurality of selections to the syndicate betting slip.

17. The sports betting system of claim 10, wherein the sports betting system performs steps to: associate a third computing device with the syndicate, wherein the syndicate betting slip is joinable by the third computing device without making a prediction wherein the third computing device receives a payout in response to the ranking of the syndicate betting slip.

18. The sports betting system of claim 15, wherein the sports betting system performs steps to: divide a reward in response to a number of sports bettors on the syndicate who made the possible predictions.

19. The sports betting system of claim 10, wherein the sports betting system performs steps to: storing a history of the syndicate betting slip on a blockchain for record keeping of the first computing device and the second computing device.

20. The sports betting system of claim 10, wherein the sports betting system performs steps to: automatically creating the syndicate in response to user specification and criteria.

21. The sports betting system of claim 10, wherein the sports betting system performs steps to: enable texting and video chat communication for a subset of the one or more syndicate members;
receiving audio and video from one or more cameras on the first computing device and the second computing device over the communications network while in a video conference; and
processing audio data, speech detection and recognition modules from the audio and the video while applying pattern recognition algorithms.

22. (canceled)

23. (canceled)

24. (canceled)

25. (canceled)

26. (canceled)

27. (canceled)

28. (canceled)

29. A sports betting system, the sports betting system comprising:
a computing system having a non-transitory computer-readable medium, the computing system having one or more processors coupled to one or more databases over a network, the computing system having a communications network that enables communications with a plurality of computing devices including a first computing device and a second computing device; the computing system having a memory coupled with and readable by the one or more processors and storing therein instructions that, when executed by the one or more processors, wherein the sports betting system performs steps to:
create a syndicate in response to a syndication creation request from a first computing device;
transmit, over the communications network, an invitation from the first computing device to the second computing device to join the syndicate;
associate the second computing device with the syndicate;
receive, over the communications network, a plurality of betting considerations of one or more sports events from the first computing device and the second computing device, the plurality of betting considerations defining an outcome associated with happenings;
notify, over the communications network, the first computing device and the second computing device of addition or removal of one of the plurality of betting considerations for a syndicate contest on a syndicate betting slip, wherein the syndicate betting slip is only submittable by users within the syndicate;
receive over the communications network, approval from the first computing device and the second computing device of the syndicate betting slip;
transforming a format of the syndicate betting slip into a suitable format needed for various contests the contest for equal comparison without having to reintroduce the plurality of betting considerations to the syndicate betting slip;
determine the outcome of the plurality of betting considerations and compare results of the plurality of betting considerations submitted by the one or more syndicates.
rank the results in response to descending order of the plurality of betting considerations against one or more second syndicates; and
transmit, via the communications network, a ranking of the plurality of betting considerations.

30. A sports betting system, the sports betting system comprising:
a computing system having a non-transitory computer-readable medium, the computing system having one or more processors coupled to one or more databases over a network, the computing system having a communications network that enables communications with a plurality of computing devices including a first computing device and a second computing device; the computing system having a memory coupled with and readable by the one or more processors and storing therein instructions that, when executed by the one or more processors, wherein the sports betting system performs steps to.
